(19) United States
(12) Patent Application Publication
(10) Pub. No.: US 2020/0336817 A1
(43) Pub. Date: Oct. 22, 2020

(54) METHOD OF CONTROLLING CHARGING LEVEL IN AUDIO DEVICE THAT IS CONNECTABLE TO ELECTRONIC DEVICE

(71) Applicant: Samsung Electronics Co., Ltd., Gyeonggi-do (KR)

(72) Inventors: Seung-Ho Lee, Seoul (KR); Yong-Yi Kim, Gyeonggi-do (KR); Chungsoon Park, Gyeonggi-do (KR); Yongjin Shin, Gyeonggi-do (KR)

(21) Appl. No.: 16/921,406

(22) Filed: Jul. 6, 2020

Related U.S. Application Data
(63) Continuation of application No. 15/347,168, filed on Nov. 9, 2016.

(30) Foreign Application Priority Data
Dec. 7, 2015 (KR) 10-2015-0173439

(51) Int. Cl. H04R 1/10

(52) U.S. Cl. CPC H04R 1/1025; H04R 5/04

(57) ABSTRACT

An electronic device is provided. The electronic device includes a wireless communication circuit; a processor electrically connected to the wireless communication circuit; and a memory electrically connected to the processor, wherein the processor is configured to establish a connection to a first earpiece and a second earpiece by using the wireless communication circuit; receive, from the first earpiece, first data that is related to a charging level of a first battery included in the first earpiece by using the wireless communication circuit; receive, from the first earpiece or the second earpiece, second data that is related to a charging level of a second battery included in the second earpiece by using the wireless communication circuit; and transmit, to at least one of the first earpiece or the second earpiece, one or more control signals that enable the first earpiece and the second earpiece to be configured to operate differently from each other based on at least some of the first data and the second data.

### PRIORITY

This application is a Continuation Application of U.S. patent application Ser. No. 15/347,168, which was filed on Nov. 9, 2016 in the U.S. Patent and Trademark Office, and claims priority under 35 U.S.C. § 119(a) to Korean Patent Application No. 10-2015-0173439, which was filed on Dec. 7, 2015 in the Korean Intellectual Property Office, the disclosure of which is incorporated herein by reference in its entirety.

### BACKGROUND

### 1. Field of the Disclosure

The present disclosure relates generally to a method for controlling the battery charging operation of interacting electronic devices, and to a device thereof, and more particularly, to a method for controlling the battery charging level of an audio device that is able to operate in pairs by interacting through wireless communication, and further provide a device thereof.

### 2. Description of the Related Art

Due to the development of digital technology, various types of electronic devices, such as mobile communication terminals, smart phones, tablet personal computers (PCs), personal digital assistants (PDAs), electronic organizers, notebook computers, wearable devices, Internet of Things (IoT) devices, and audio devices, are being used widely.

Electronic devices may be connected to a variety of audio devices (e.g., wired headsets, wired earphones, wireless headsets, wireless earphones). An electronic device may output audible data (e.g., sound) through an audio device, and a user may listen to the audible data through the audio device. An electronic device and an audio device may be connected to each other through a wired interface (e.g., a connector) or a wireless interface (e.g. a Bluetooth connection).

In recent years, wireless earphones have been developed as an audio device, which operates in pairs. A wireless earphone may include a first earpiece and a second earpiece, which are worn in a user's ears, respectively, where each earpiece may include a battery. In a wireless earphone, the earpieces may have different battery voltages depending on usage method and the environment. Accordingly, one earpiece having a low voltage may turn off while the other earpiece is on, causing the sound being listened to by a user to lose the characteristic of stereo.

### SUMMARY

An aspect of the present disclosure provides a method for controlling the battery charging level of an audio device that is able to operate in pairs by interacting through wireless communication, and further provide a device thereof.

In accordance with an aspect of the present disclosure, a mobile electronic device is provided. The mobile electronic device includes a wireless communication circuit; a processor electrically connected to the wireless communication circuit; and a memory electrically connected to the processor, wherein the processor is configured to establish a connection to a first earpiece and a second earpiece by using the wireless communication circuit; receive, from the first earpiece, a first data that is related to a charging level of a first battery included in the first earpiece by using the wireless communication circuit; receive, from the first earpiece or the second earpiece, the second data that is related to the charging level of a second battery included in the second earpiece by using the wireless communication circuit; and transmit, to at least one of the first earpiece or the second earpiece, one or more control signals that enable the first earpiece and the second earpiece to be configured to operate differently from each other based on at least some of the first data and the second data.

In accordance with another aspect of the present disclosure, an earpiece is provided. The earpiece includes a housing including a portion that is detachably mounted on a user's ear; a speaker included in the housing; a first battery included in the housing: one or more wireless communication circuits included in the housing; a processor included in the housing and electrically connected to the one or more wireless communication circuits; and a memory included in the housing and electrically connected to the processor, wherein the processor is configured to establish a connection to an electronic device or another earpiece by using the one or more wireless communication circuits; receive, from the electronic device, a first control information that enables the earpiece, or the earpiece and the another earpiece, to be configured to perform a first selected operation and a second control information that enables the earpiece to be configured to perform a second selected operation or enables the another earpiece to not perform the second selected operation by using the one or more communication circuits; enable the earpiece to perform the first selected operation based on the first control information; and transmit the first control information or the second control information to the another earpiece by using the one or more wireless communication circuits.

In accordance with another aspect of the present disclosure, an earpiece is provided. The earpiece includes a housing including a portion that is detachably mounted on a user's ear; a speaker included in the housing; a battery included in the housing; a wireless communication circuit included in the housing; a processor included in the housing and electrically connected to the wireless communication circuit; and a memory included in the housing and electrically connected to the processor, wherein the processor is configured to establish connections to an electronic device and another earpiece by using the wireless communication circuit; detect a charging level of the battery in order to thereby create data; transmit the created data to at least one of the electronic device or the earpiece; receive, from the electronic device or the earpiece, one or more control signals that enable another earpiece to perform a selected operation; and enable the another earpiece to perform the selected operation based on the one or more control signals.

In accordance with another aspect of the present disclosure, an electronic device is provided. The electronic device includes a housing; a communication circuit disposed in the housing; a power interface disposed in the housing; and a control circuit electrically connected to the communication circuit and the power interface, wherein the housing includes one or more fixing members configured to accommodate a first earpiece including a first battery and a second earpiece including a second battery, wherein the control circuit is configured to establish connections to the first earpiece and the second earpiece by using the communication circuit; receive, from the first earpiece, a first data that is related to a charging level of the first battery; receive, from the second earpiece, a second data that is related to a charging level of the second battery; and supply charging power to at least one of the first earpiece or the second earpiece selectively, or at a different ratio, through the power interface based on at least some of the first data and the second data.

In accordance with another aspect of the present disclosure, a method of an electronic device is provided. The method includes establishing connections to a first earpiece and a second earpiece by a wireless communication circuit; receiving, from the first earpiece, a first data that is related to a charging level of a first battery included in the first earpiece; receiving, from the first earpiece or the second earpiece, a second data that is related to a charging level of a second battery included in the second earpiece; and transmitting, to at least one of the first earpiece or the second earpiece, one or more control signals that enable the first earpiece and the second earpiece to operate differently from each other based on at least some of the first data and the second data.

In accordance with another aspect of the present disclosure, a method of an earpiece is provided. The method includes establishing a connection to an electronic device using a communication circuit; receiving, from the electronic device, control information that enables the earpiece or another earpiece to perform a selected operation; enabling the earpiece to perform a first selected operation based on the control information; and selectively transmitting the control information to the another earpiece.

In accordance with another aspect of the present disclosure, a method of an electronic device is provided. The method includes establishing connections to a first earpiece and a second earpiece by using a communication circuit; receiving, from the first earpiece, a first data that is related to a charging level of a first battery; receiving, from the second earpiece, a second data that is related to a charging level of a second battery; and supplying charging power to at least one of the first earpiece or the second earpiece selectively, or at a different ratio, based on at least some of the first data and the second data.

### BRIEF DESCRIPTION OF THE DRAWINGS

The above and other aspects, features, and advantages of the present disclosure will be more apparent from the following detailed description, taken in conjunction with the accompanying drawings, in which:

FIG. 1 is a block diagram of a network environment that includes an electronic device, according to an embodiment of the present disclosure;

FIG. 2 is a block diagram of an electronic device, according to an embodiment of the present disclosure;

FIG. 3 is a block diagram of a program module, according to an embodiment of the present disclosure;

FIG. 4 is a diagram of a system, according to an embodiment of the present disclosure;

FIG. 5 is a diagram of a battery charging level of an audio device in a system, according to an embodiment of the present disclosure;

FIGS. 6 and 7 are diagrams of an electronic device and an audio device in a system, according to an embodiment of the present disclosure of the present disclosure;

FIG. 8 is a block diagram of an electronic device, according to an embodiment of the present disclosure;

FIG. 9 is a block diagram of an audio device, according to an embodiment of the present disclosure;

FIG. 10 is a flowchart of a method of an electronic device, according to an embodiment of the present disclosure;

FIG. 11 is a flowchart of a method of an audio device, according to an embodiment of the present disclosure;

FIG. 12 is a flowchart of a method of an audio device, according to an embodiment of the present disclosure;

FIG. 13 is a flowchart of a method of an audio device, according to an embodiment of the present disclosure;

FIGS. 14 and 15 are diagrams of changing a host device in a system, according to an embodiment of the present disclosure;

FIG. 16 is a flowchart of a method of changing a host device in an electronic device, according to an embodiment of the present disclosure;

FIGS. 17A to 17D are diagrams of charging an audio device, according to an embodiment of the present disclosure;

FIG. 18 is a block diagram of a charging device, according to an embodiment of the present disclosure;

FIG. 19 is a block diagram of a charging device, according to an embodiment of the present disclosure;

FIG. 20 is a flowchart of a method of charging an audio device in a charging device, according to an embodiment of the present disclosure; and

FIG. 21 is a flowchart of a method of charging an audio device in a charging device, according to an embodiment of the present disclosure.

### DETAILED DESCRIPTION OF EMBODIMENTS OF THE PRESENT DISCLOSURE

Hereinafter, various embodiments of the present disclosure are described with reference to the accompanying drawings. However, it should be understood that there is no intent to limit the present disclosure to the particular embodiments disclosed herein; rather, the present disclosure is intended to be construed to cover various modifications, equivalents, and/or alternatives of the present disclosure that are within the scope of the present disclosure as defined by the appended claims and their equivalents. In describing the accompanying drawings, similar reference numerals may be used to designate similar elements.

As used herein, the expressions “have,” “may have,” “include,” or “may include” refer to the existence of a corresponding feature (e.g., a numeral, a function, an operation, or an element such as a component), but do not exclude one or more additional features.

In the present disclosure, the expressions “A or B,” “at least one of A and/or B,” and “one or more of A and/or B” may include all possible combinations of the items listed. For example, the expressions “A or B,” “at least one of A and B,” and “at least one of A or B” refer to all of (1) including at least one A, (2) including at least one B, and (3) including all of at least one A and at least one B.

The expressions “a first,” “a second,” “the first,” or “the second” used in various embodiments of the present disclosure may modify various components regardless of order and/or importance, but do not limit the corresponding components. For example, a first user device and a second user device indicate different user devices although both of them are user devices. For example, a first element may be referred to as a second element, and similarly, a second element may be referred to as a first element without departing from the scope of the present disclosure.

It should be understood that if an element (e.g., a first element) is referred to as being (operatively or communicatively) “connected,” or “coupled,” to another element (e.g., a second element), it may be directly connected or directly coupled to the other element, and another element (e.g., a third element) may be interposed therebetween. In contrast, it may be understood that if an element (e.g., a first element) is referred to as being “directly connected,” or “directly coupled,” to another element (e.g., a second element), there is no element (e.g., a third element) interposed therebetween.

The expression “configured to” used in the present disclosure may be substituted with, for example, “suitable for,” “having the capacity to,” “designed to,” “adapted to,” “made to,” or “capable of,” according to the situation. The term “configured to” may not necessarily imply “specifically designed to” in hardware. Alternatively, in some situations, the expression “device configured to” may indicate that the device, together with other devices or components, “is able to.” For example, the phrase “processor adapted (or configured) to perform A, B, and C” may indicate a dedicated processor (e.g. an embedded processor) only for performing the corresponding operations or a general purpose processor (e.g., a central processing unit (CPU) or an application processor (AP)) that can perform the corresponding operations by executing one or more software programs stored in a memory device.

The terms used in the present disclosure are only used to describe certain embodiments, and are not intended to limit the present disclosure. As used herein, singular forms may include plural forms as well, unless the context clearly indicates otherwise. Unless defined otherwise, all terms used herein have the same meanings as those commonly understood by a person skilled in the art to which the present disclosure pertains. Such terms as those defined in a generally used dictionary may be interpreted to have the same meanings as the contextual meanings in the relevant field of art, and are not to be interpreted to have ideal or excessively formal meanings, unless clearly defined in the present disclosure. In some cases, even a term defined in the present disclosure should not be interpreted to exclude embodiments of the present disclosure.

An electronic device according to an embodiment of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a moving picture experts group (MPEG-1) audio layer-3 (MP3) player, a mobile medical device, a camera, and a wearable device. According to an embodiment of the present disclosure, a wearable device may include at least one of an accessory type (e.g., a watch, a ring, a bracelet, an anklet, a necklace, glasses, contact lenses, or a head-mounted device (HMD)), a fabric or clothing integrated type (e.g., electronic clothing), a body-mounted type (e.g., a skin pad, a tattoo), and a bio-implantable type (e.g., an implantable circuit).

According to an embodiment of the present disclosure, an electronic device may be a home appliance. The home appliance may include at least one of, for example, a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TV™), a game console (e.g., Xbox® and PlayStation®), an electronic dictionary, an electronic key, a camcorder, and an electronic photo frame.

According to an embodiment of the present disclosure, an electronic device may include at least one of various medical devices (e.g., various portable medical measuring devices (e.g., a blood glucose monitoring device, a heart rate monitoring device, a blood pressure, measuring device, a body temperature measuring device, etc.), a magnetic resonance angiography (MRA) device, a magnetic resonance imaging (MRI) device, a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automated teller machine (ATM) for a bank, point of sales (POS) device in a shop, or IoT device (e.g., a light bulb, various sensors, electric or gas meter, a sprinkler device, a fire alarm, a thermostat, a streetlamp, a toaster, sporting goods, a hot water tank, a heater, a boiler, etc.).

According to an embodiment of the present disclosure, an electronic device may include at least one of a part of furniture or a building/structure, an electronic board, an electronic signature receiving device, a projector, and various kinds of measuring instruments (e.g., a water meter, an electric meter, a gas meter, and a radio wave meter). An electronic device according to an embodiment of the present disclosure may be a combination of one or more of the aforementioned various devices. An electronic device according to an embodiment of the present disclosure may be a flexible device. Further, an electronic device according to an embodiment of the present disclosure is not limited to the aforementioned devices, but may include an electronic device developed in the future.

Hereinafter, an electronic device according to an embodiment of the present disclosure is described with reference to the accompanying drawings. As used herein, the term “user” may indicate a person who uses an electronic device or a device (e.g., an electronic device that employs artificial intelligence) that uses an electronic device.

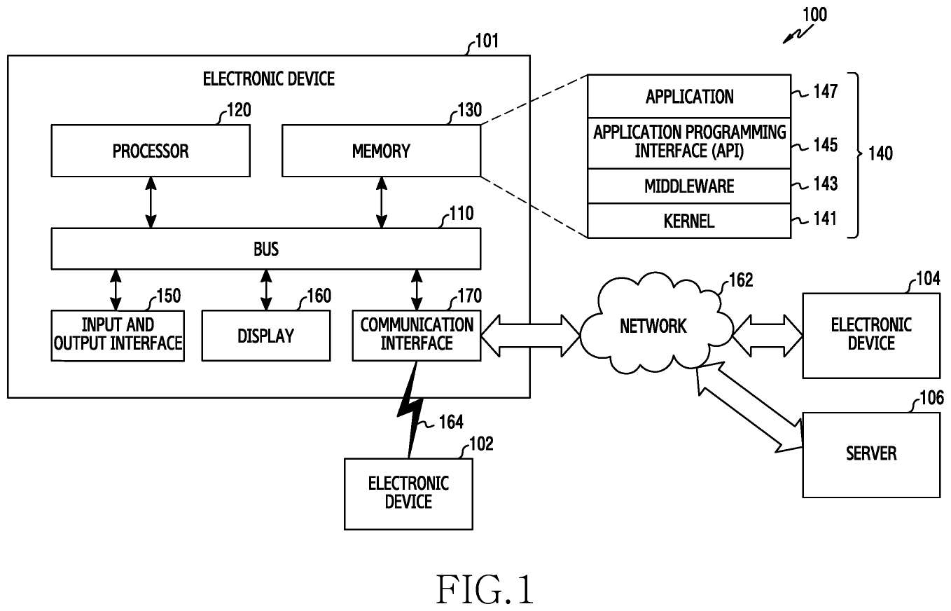

FIG. 1 is a block diagram of a network environment 100 that includes an electronic device 101, according to an embodiment of the present disclosure.

Referring to FIG. 1, electronic device 101 may include a bus 110, a processor 120, a memory 130, an input/output interface 150, a display 160, and a communication interface 170. According to an embodiment of the present disclosure, the electronic device 101 may omit at least one of the above components 110 to 170 or may further include other components.

The bus 110 may include, for example, a circuit which interconnects the components 110 to 170 and delivers a communication (e.g., a control message and/or data) between the components 110 to 170.

The processor 120 may include one or more of a CPU, an AP, and a communication processor (CP). The processor 120 may carry out, for example, a calculation or process data relating to control and/or communication of at least one other component 110 to 170 of the electronic device 101.

The memory 130 may include a volatile memory and/or a non-volatile memory.

The memory 130 may store, for example, commands or data relevant to at least one other component 110 to 170 of the electronic device 101. According to an embodiment of the present disclosure, the memory 130 may store software and/or a program 140. The program 140 may include, for example, a kernel 141, middleware 143, an application programming interface (API) 145, and/or an application program (or “application”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented in the other programs (e.g., the middleware 143, the API 145, or the application 147). Furthermore, the kernel 141 may provide an interface through which the middleware 143, the API 145, or the application 147 may access the individual components 110 10 170 of the electronic device 101 to control or manage system resources.

The middleware 143, for example, may serve as an intermediary for enabling the API 145 or the application 147 to communicate with the kernel 141 to exchange data.

Also, the middleware 143 may process one or more task requests received from the application 147 according to priorities thereof. For example, the middleware 143 may assign priorities for using system resources (e.g., the bus 110, the processor 120, the memory 130, or the like) of the electronic device 101, to at least one application 147. For example, the middleware 143 may perform scheduling or loading balancing on one or more task requests by processing the one or more task requests according to the priorities assigned thereto.

The API 145 is an interface through which the application 147 controls functions provided from the kernel 141 or the middleware 143, and may include, for example, at least one interface or function (e.g., an instruction) for file control, window control, image processing, character control, and the like.

The input/output interface 150, for example, may function as an interface that may transfer commands or data input from a user or another external device to the other element(s) 110 to 170 of the electronic device 101. Furthermore, the input/output interface 150 may output commands or data received from the other element(s) 110 to 170 of the electronic device 101 to a user or another external device.

Examples of the display 160 may include a liquid crystal display (LCD), a light emitting diode (LED) display, an organic LED (OLED) display, a micro electro-mechanical systems (MEMS) display, and an electronic paper display. The display 160 may display, for example, various types of contents (e.g., text, images, videos, icons, or symbols) to users. The display 160 may include a touch screen, and may receive, for example, a touch, a gesture, a proximity input, or a hovering input using an electronic pen or a part of a user's body.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with the second external electronic device 104 or the server 106. The wireless communication may use at least one of, for example, long term evolution (LTE), LTE-Advance (LTE-A), code division multiple access (CDMA), wideband CDMA (WCDMA), a universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, wireless fidelity (Wi-Fi), Bluetooth, near field communication (NFC), and a global navigation satellite system (GNSS). GNSS may include, for example, at least one of GPS, globalnaya navigazionnaya sputnikovaya sistema (or global navigation satellite system) (Glonass), Beidou navigation satellite system (Beidou), and the European GNSS (Galileo), based on a location, a bandwidth, or the like. Hereinafter, in the present disclosure, the “GPS” may be substituted with the “GNSS.” The wired communication may include, for example, at least one of a universal serial bus (USB), a high definition multimedia interface (HDMI), recommended standard 232 (RS-232), and a plain old telephone service (POTS). The network 162 may include at least one of a telecommunication network such as a computer network (e.g., a local area network (LAN) or a wide area network (WAN)), the Internet, and a telephone network.

Each of the first and second external electronic devices 102 and 104 may be of a type identical to, or different from, that of the electronic device 101. According to an embodiment of the present disclosure, the server 106 may include a group of one or more servers. According to an embodiment of the present disclosure, all or some of the operations performed in the electronic device 101 may be executed in the electronic devices 102 and 104 or the server 106. According to an embodiment of the present disclosure, if the electronic device 101 must perform some functions or services automatically or in response to a request, the electronic device 101 may request the electronic device 102 or 104 or the server 106 to execute at least some functions relating thereto instead of, or in addition to, autonomously performing the functions or services. The electronic device 102 or 104, or the server 106 may execute the requested functions or the additional functions, and may deliver the result of the execution to the electronic device 101. The electronic device 101 may process a received result as is or may additionally process the received result, and may provide the requested functions or services. For example, cloud computing, distributed computing, or client-server computing technologies may be used.

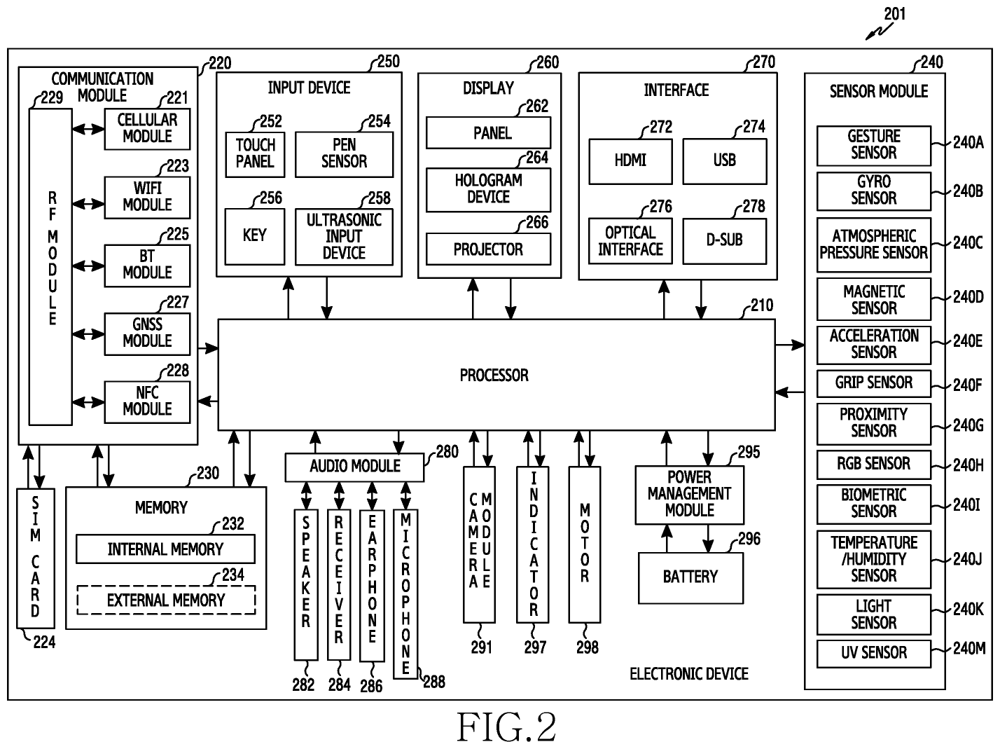

FIG. 2 is a block diagram of an electronic device 201, according to an embodiment of the present disclosure.

The electronic device 201 may include, for example, all, or a part, of the electronic device 101 shown in FIG. 1. The electronic device 201 may include one or more processors 210 (e.g., AP), a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, process various pieces of data, and perform various calculations. The processor 210 may be embodied as, for example, a system on chip (SoC). According to an embodiment of the present disclosure, the processor 210 may further include a graphics processing unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components, and process loaded commands or data, and store various data in a non-volatile memory.

The communication module 220 may have a configuration equal, or similar, to that of the communication interface 170 of FIG. 1. The communication module 220 may include, for example, the cellular module 221, a Wi-Fi module 223, a BT module 225, a GNSS module 227 (e.g., a GPS module, a Glonass module, a Beidou module, or a Galileo module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using the SIM card 224. The cellular module 221 may perform at least some of the functions that the AP 210 may provide. The cellular module 221 may include a CP.

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one integrated circuit (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to another embodiment of the present disclosure, at least one of the cellular module 221, the Wi-Fi module 223, the BT module 225, the GNSS module 227, and the NFC module 228 may transmit/receive an RF signal through a separate RF module.

The SIM card 224 may include, for example, unique identification information (e.g., an integrated circuit card identifier (ICCID)) or subscriber information (e.g., an international mobile subscriber identity (IMSI)).

The memory 230 (e.g., the memory 130) may include, for example, an internal memory 232 or an external memory 234. The internal memory 232 may include at least one of a volatile memory (e.g., a dynamic random access memory (DRAM), a static RAM (SRAM), a synchronous DRAM (SDRAM), and the like) and a non-volatile memory (e.g., a one time programmable read only memory (OTPROM), a programmable ROM (PROM), an erasable PROM (EPROM), an electrically erasable PROM (EEPROM), a mask ROM, a flash ROM, a flash memory (e.g., a NAND flash memory or a NOR flash memory), a hard disk drive, a solid state drive (SSD), and the like).

The external memory 234 may further include a flash drive, for example, a compact flash (CF) drive, a secure digital (SD) drive, a micro SD (Micro-SD) drive, a mini SD (Mini-SD) drive, an extreme digital (xD) drive, a multimedia card (MMC), a memory stick, or the like. The external memory 234 may be functionally and/or physically connected to the electronic device 201 through various interfaces.

The sensor module 240, for example, may measure a physical quantity or detect an operational state of the electronic device 201, and may convert the measured or detected information into an electrical signal. The sensor module 240 may include, for example, at least one of a gesture sensor 240A, a gyro sensor 240B, an atmospheric pressure sensor (e.g., a barometer) 240C, a magnetic sensor 240D, an acceleration sensor 240E, a grip sensor 240F, a proximity sensor 240G, a color sensor 240H (e.g., a red, green, and blue (RGB) color sensor), a biometric sensor (e.g. a medical sensor) 2401, a temperature/humidity sensor 240J, a light sensor 240K, and an ultra violet (UV) light sensor 240M. Additionally, or alternatively, the sensor module 240 may include, for example, an electronic nose (E-nose) sensor, an electromyography (EMG) sensor, an electroencephalogram (EEG) sensor, an electrocardiogram (ECG) sensor, an infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a reduced power (e.g. sleep) state.

The input device 250 may include, for example, a touch panel 252, a (digital) pen sensor 254, a key 256, or an ultrasonic input device 258. The touch panel 252 may use, for example, at least one of a capacitive type panel, a resistive type panel, an infrared type panel, and an ultrasonic type panel. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone 288, ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may provide a three dimensional (3D) image in the air by using an interference of light. The projector 266 may project light onto a screen to display an image. The screen may be, for example, internal, or external, to the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) connector 278. The interface 270 may be included in, for example, the communication interface 170 illustrated in FIG. 1. Additionally, or alternatively, the interface 270 may include, for example, a mobile high-definition link (MHL) interface, an SD card/multimedia card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, an earphone 286, or the microphone 288.

The camera module 291 is, for example, a device which may photograph a still image or a video. According to an embodiment of the present disclosure, the camera module 291 may include one or more image sensors (e.g., a front sensor or a back sensor), a lens, an image signal processor (ISP) or a flash (e.g., an LED or xenon lamp).

The power management module 295 may manage, for example, power of the electronic device 201. According to an embodiment of the present disclosure, the power management module 295 may include a power management IC (PMIC), a charger IC, or a battery gauge. The PMIC may use a wired and/or a wireless charging method. Examples of a wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. The electronic device 201 may include a processing device (e.g., a GPU) for supporting a mobile TV. The processing device for supporting a mobile TV may process, for example, media data according to a certain standard such as digital multimedia broadcasting (DMB), digital video broadcasting (DVB), or mediaFLO™.

Each of the above-described component elements of hardware according to the present disclosure may be configured with one or more components, and the names of the corresponding component elements may vary based on the type of electronic device. In an embodiment of the present disclosure, an electronic device may include at least one of the above-described elements. Some of the above-described elements may be omitted from the electronic device, or the electronic device may further include additional elements. Also, some of the hardware components may be combined into one entity, which may perform functions identical to those of the relevant components before the combination.

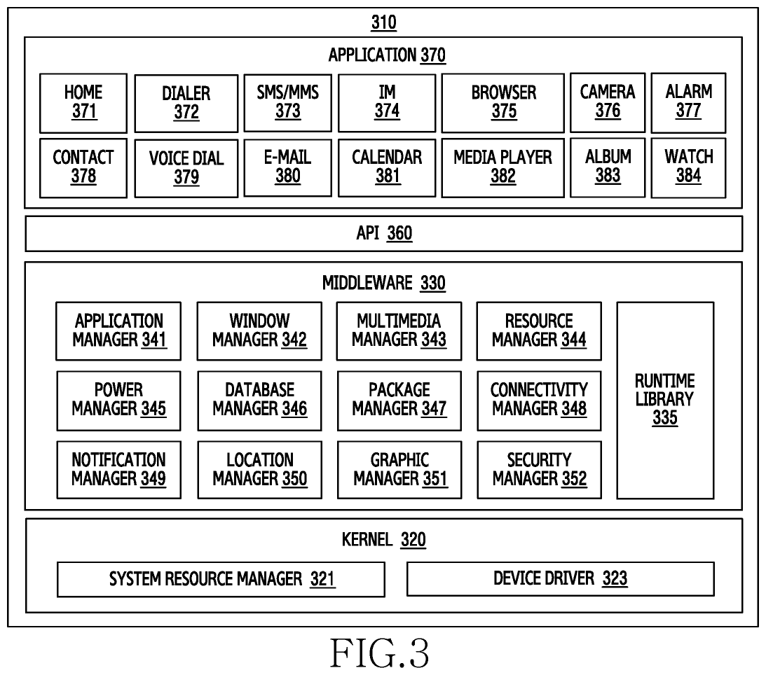

FIG. 3 is a block diagram of a program module 310, according to an embodiment of the present disclosure.

Referring to FIG. 3, the program module 310 (e.g., the program 140) may include an OS for controlling resources related to the electronic device (e.g., the electronic device 101) and/or various applications (e.g., the application 147) executed in the OS. The OS may be, for example, Android®, iOS®, Windows®, Symbian™, Tizen®, Bada™, or the like.

The program module 310 may include a kernel 320, middleware 330, an API 360, and/or an application 370. At least some of the program module 310 may be preloaded on an electronic device, or may be downloaded from the electronic device 102 or 104, or the server 106.

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

For example, the middleware 330 may provide a function required in common by the application 370, or may provide various functions to the application 370 through the API 360 so as to enable the application 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the application 370 is being executed. The runtime library 335 may perform input/output management, memory management, the functionality for an arithmetic function, or the like.

The application manager 341 may manage, for example, a life cycle of at least one of the application 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of source code, a memory, and a storage space of at least one application of the application 370.

The power manager 345 may operate together with, for example, a basic input/output (BIOS) or the like to manage a battery or a power source and may provide power information or the like required for operations of the electronic device. The database manager 346 may generate, search for, and/or change a database to be used by at least one of the applications of the application 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival of a message, a promise, a proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, if the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android® or iOS®, one API set may be provided for each platform. In the case of Tizen®, two or more API sets may be provided for each platform.

The application 370 (e.g., the application 147) may include, for example, one or more applications which may provide functions such as a home application 371, a dialer 372 application, a short message service/multimedia messaging services (SMS/MMS) application 373, an instant message (IM) application 374, a browser application 375, a camera application 376, an alarm application 377, a contacts application 378, a voice dial application 379, an email application 380, a calendar application 381, a media player application 382, an album application 383, a clock application 384, a health care application (e.g., an application that measures an exercise quantity or a blood sugar level), or an environmental information application (e.g., an application that provides atmospheric pressure, humidity, or temperature information).

According to an embodiment of the present disclosure, the application 370 may include an application (hereinafter, referred to as an information exchange application) that supports exchanging information between the electronic device (e.g., the electronic device 101) and the electronic device 102 or 104. The information exchange application may include, for example, a notification relay application for transferring certain information to an external electronic device or a device management application for managing an external electronic device.

For example, the notification relay application may include a function of transferring, to the electronic device 102 or the electronic device 104, notification information generated from other applications of the electronic device 101 (e.g., an SMS/MMS application 373, an e-mail application 380, a health management application, or an environmental information application). Further, the notification relay application may receive notification information from, for example, an external electronic device and provide the received notification information to a user.

The device management application may manage (e.g., install, delete, or update), for example, at least one function of the electronic device 102 or the electronic device 104 communicating with the electronic device (e.g., a function of turning on/off the external electronic device (or some components) or a function of adjusting the brightness (or a resolution) of the display), applications operating in the external electronic device, and services provided by the external electronic device (e.g., a call service or a message service).

According to an embodiment of the present disclosure, the application 370 may include applications (e.g., a health care application of a mobile medical appliance or the like) designated according to attributes of the electronic device 102 or the electronic device 104. The application 370 may include an application received from the server 106, the electronic device 102, or the electronic device 104. The application 370 may include a preloaded application or a third party application that may be downloaded from a server. The names of the components of the program module 310 of an embodiment of the present disclosure may change according to the type of an OS.

According to an embodiment of the present disclosure, at least a part of the programming module 310 may be implemented in software, firmware, hardware, or a combination of two or more thereof. At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

The term “module” as used herein may, for example, indicate a unit including one of hardware, software, and firmware or a combination of two or more of them. The term “module” may be substituted with, for example, the terms “unit,” “logic,” “logical block,” “component,” and “circuit.” The term “module” may indicate a minimum unit of an integrated component element or a part thereof. The term “module” may be a minimum unit for performing one or more functions or a part thereof. The term “module” may be mechanically or electronically implemented. For example, the term “module” may include at least one of an application specific IC (ASIC), a field programmable gate array (FPGA), and a programmable-logic device for performing operations which has been known or are to be developed hereinafter.

According to an embodiment of the present disclosure, at least some of the devices (for example, modules or functions thereof) or the method (for example, operations) may be implemented by a command stored in a computer-readable storage medium in a programming module form. An instruction, if executed by a processor (e.g., the processor 120), may cause the one or more processors to execute the function corresponding to the instruction. The computer-readable storage medium may be, for example, the memory 130.

The computer-readable storage medium may include a hard disk, a floppy disk, magnetic media (e.g., a magnetic tape), optical media (e.g., a compact disk ROM (CD-ROM) and a DVD)), magneto-optical media (e.g., a floptical disk), a hardware device (e.g., a ROM, a RAM, a flash memory), and the like. In addition, the program instructions may include high level language code, which can be executed in a computer by using an interpreter, as well as machine code generated by a compiler. The aforementioned hardware device may be configured to operate as one or more software modules in order to perform the operation of the present disclosure, and vice versa.

Any of the modules or programming modules according to an embodiment of the present disclosure may include at least one of the above described elements, exclude some of the elements, or further include other additional elements. The operations performed by the modules, programming module, or other elements may be executed in a sequential, parallel, repetitive, or heuristic manner. Further, some operations may be executed according to another order or may be omitted, or other operations may be added.

Various embodiments of the present disclosure are provided merely to easily describe technical details of the present disclosure and to help the understanding of the present disclosure, but are not intended to limit the scope of the present disclosure. Therefore, it is intended that all modifications and changes or modified and changed forms based on the present disclosure within the scope of the appended claims and their equivalents fall within the scope of the present disclosure.

An embodiment of the present disclosure discloses a method for adjusting a state of a battery of an audio device (e.g., an earpiece), which is able to operate with another earpiece through wireless communication, according to a user's scenario, and a device thereof. The remaining amount of battery power of two earpieces, which are able to operate in pairs through short-range communication, may be maintained to be the same or similar.

The electronic device, according to an embodiment of the present disclosure, may include all devices that support a communication function and/or a charging function and use one or more of various processors, such as an AP, a CP, a GPU, and/or a CPU. For example, the electronic device may include all information communication devices, multimedia devices, wearable devices, IoT devices, or audio devices, which include a battery and support a communication function and/or a charging function, or may include application devices thereof.

Hereinafter, an operating method and a device, according to various embodiments of the present disclosure, is described with reference to the accompanying drawings. However, since the various embodiments are not restricted or limited by the following description, it should be noted that applications may be made to the various embodiments based on embodiments that are described below. Hereinafter, various embodiments of the present disclosure are described based on an approach of hardware. However, various embodiments of the present disclosure may use both hardware and software and thus, the various embodiments of the present disclosure may not exclude software.

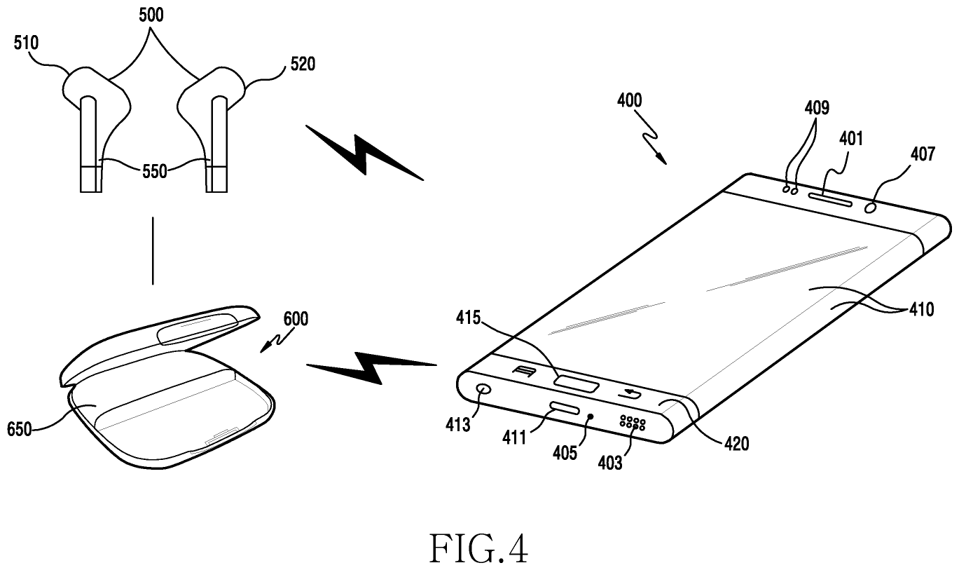

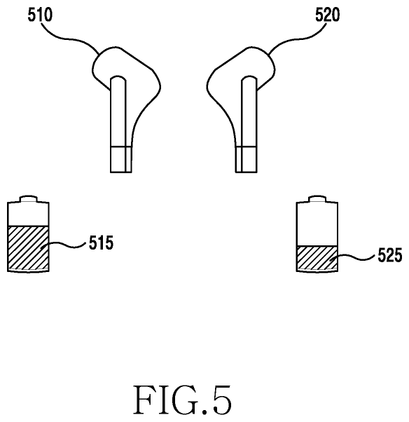

FIG. 4 is a diagram of a system, according to an embodiment of the present disclosure. FIG. 5 is a diagram of a battery charging level of an audio device in a system, according to an embodiment of the present disclosure.

Referring to FIG. 4, a system, according to an embodiment of the present disclosure, may include an electronic device 400, audio devices 500, and a charging device 600.

In an embodiment of the present disclosure, the electronic device 400 may be configured to include a display 410; a housing (or body) 420 on which the display 410 is mounted; and additional devices that are formed in the housing 420 in order to thereby execute functions of the electronic device 400. The additional devices may include a first speaker 401, a second speaker 403, a microphone 405, sensors (such as a front camera module 407, an illuminance sensor 409, or the like), communication interfaces (e.g., a charging or data input/output port 411, an audio input/output port 413, or the like), a button 415, or the like.

In an embodiment of the present disclosure, the display 410 may include a bent display that may be curved, bent, or rolled without damage through a thin and flexible substrate like paper. The bent display may be coupled to the housing 420 so that the curved shape thereof may be maintained. In various embodiments, in addition to the bent display, the electronic device 400 may be implemented by a display device that may be freely bent and unfolded, such as flexible displays. The display 410 may have the flexibility to be folded and unfolded by replacing glass substrates, which enclose a liquid crystal in an LCD, an LED display, an OLED display, or an active matrix OLED (AMOLED) display, with plastic films. The display 410 may be extended to at least one side (for example, at least one of the left side, the right side, the upper side, or the lower side) of the electronic device 400, and the bent display may be folded to be equal to, or less than, an operable radius of curvature (e.g., a radius of curvature of 5 cm, 1 cm, 7.5 mm, 5 mm, 4 mm, or the like) to then be coupled to the side of the housing 420.

In an embodiment of the present disclosure, if the audio devices 500 are connected, the electronic device 400 may determine the battery charging level (e.g., information on the remaining amount of the battery) corresponding to the audio devices 500. The electronic device 400 may control the operation of the audio devices 500 (e.g., the first audio device 510 and the second audio device 520) based on the battery charging level of the audio devices 500.

According to an embodiment of the present disclosure, the electronic device 400 may control the first audio device 510 and the second audio device 520 to perform a first function (e.g., a stereo audio output function based on the first audio device 510 and the second audio device 520) that is performed by the interaction between the electronic device 400 and the audio devices 500. The electronic device 400 may adjust the balance of the battery charging level between the first audio device 510 and the second audio device 520 if controlling the operation of the audio devices 500 according to the first function. If the electronic device 400 detects that the battery charging level of one (e.g., the first audio device 510) of the first audio device 510 or the second audio device 520 is lowered to be equal to, or less than, a reference voltage (e.g., 3.6V), the electronic device 400 may adjust the sound quality, which is to be transmitted to an audio device (e.g., the first audio device 510) of which the battery level is lowered to be less than or equal to the reference voltage, to be lower (e.g., 192 Kbps to 96 Kbps) than the sound quality that is transmitted to the other audio device (e.g., the second audio device 520), and may transmit the same.

According to an embodiment of the present disclosure, the electronic device 400 may control the audio device, of which the battery charging level is high, to perform a second function (such as a call function, an alarm function, a speech recognition function, a connection function, or the like), which is performed by the interaction between the electronic device 400 and the audio devices 500. For example, as shown in FIG. 5, if the battery charging level (e.g., the remaining amount of battery) 515 of the first audio device 510 is greater than the battery charging level 525 (e.g., the remaining amount of battery) of the second audio device 520, the electronic device 400 may make a control to perform related operations for the second function by interaction with the first audio device 510. For example, if the battery charging level of the first audio device 510 is greater than the battery charging level of the second audio device 520, the electronic device 400 may make a control to perform the second function based on the first audio device 510. The electronic device 400 may compare the voltage of the first audio device 510 with the voltage of the second audio device 520, and may make a control to give priority for performing the second function to the audio device of a high voltage (e.g., the first audio device 510) to then perform the second function. The electronic device 400 may control the second audio device 520 to operate in the standby state (e.g., the sleep state) in order to thereby minimize the current consumption of the second audio device 520.

According to an embodiment of the present disclosure, although the battery charging level of the first audio device 510 is greater than the battery charging level of the second audio device 520, the user may wear only the second audio device 520 in an ear without recognizing the same. The electronic device 400 may obtain, from the audio devices 500, sensed information that is measured by various sensors provided in the audio devices 500, and may determine the audio device (e.g., at least one of the first audio device 510 or the second audio device 520) that is worn in the user's ear based on the same. For example, if the electronic device 400 detects that only the second audio device 520 is worn in the user's ear, even though the battery charging level of the first audio device 510 is greater than the battery charging level of the second audio device 520, the electronic device 400 may make a control to perform the second function of which the priority is given to the first audio device 510 by interacting with the second audio device 520.

In an embodiment of the present disclosure, examples of controlling the operation according to the battery charging level of the audio devices 500 by the electronic device 400 is described below in detail with reference to the accompanying drawings.

In an embodiment of the present disclosure, the audio devices 500 may refer to an audio output device that is connected with the electronic device 400 by wireless conununication and receives audio signals of audio data reproduced in the electronic device 400 in order to thereby output the received audio signals through a speaker (or a receiver). The audio devices 500 may be configured by a pair of audio devices, such as the first audio device 510 and the second audio device 520 for the left ear and the right ear of the user, respectively. The audio devices 500 including the first audio device 510 and the second audio device 520 may be worn on the user's body (e.g., a left ear or a right ear), and may provide sound information through speakers. The audio devices 500 may be configured to include a processor, an input unit (e.g., a microphone), an output unit (e.g., a receiver/speaker), a communication control unit (e.g., a communication module), a storage unit (e.g., a memory), or the like. The audio devices 500 may be configured to include a variety of sensors (such as a heart rate monitor (HRM) sensor, a gyro sensor, a geomagnetic sensor, a GPS sensor, a body temperature detection sensor, or the like).

In an embodiment of the present disclosure, the audio devices 500 may include a housing (or a body) 550, and the housing 550, for example, may include a portion that is detachably mounted on the user's ear, a speaker, a battery, a wireless communication circuit, a memory, a processor, or the like.

In an embodiment of the present disclosure, the audio devices 500 may be connected to the electronic device 400 (e.g., a mobile device, a smart phone, a tablet PC, or the like) by wireless communication. For example, in the case of wireless communication, the audio devices 500 may process the audio signals (e.g., applying an audio filter or amplifying the signal) received through an antenna, and may output sound through the output unit. The audio devices 500 may analyze the input audio signal, and if the input audio signal is determined to be noise, the audio devices 500 may eliminate the input audio signal. If no audio signal more than a certain value is generated for a certain period of time, the audio devices 500 may operate, at least in part, in the low power mode.

In an embodiment of the present disclosure, the first audio device 510 and the second audio device 520 of the audio devices 500 may be charged (e.g., wired charging or wireless charging) by interacting with the charging device 600. For example, if the audio devices 500 are placed on the charging device 600, the audio devices 500 may perform the charging operation based on the voltage supplied from the charging device 600. The audio devices 500 may be applied with the power, which is transmitted through an electrical circuit from the charging device 600, through an electrical circuit, and may charge the internal battery based on the applied power.

According to an embodiment of the present disclosure, the audio devices 500 may exchange information (e.g., power information) on the charging power (e.g., the charging voltage and the charging current) with the charging device 600 by using communication. For example, the audio devices 500 and the charging device 600 may perform communication for the transmission and reception of information through each electrical circuit. Alternatively, the audio devices 500 and the charging device 600 may perform communication for the transmission and reception of information through short-range communication (e.g., Bluetooth low energy (BLE), Zigbee, near field magnetic induction (NFMI), NFC, or the like).

According to an embodiment of the present disclosure, the audio devices 500 may selectively receive at least one of a plurality of charging powers from the charging device 600. The audio devices 500 may process the battery charging by using at least one charging power, which is selected. For example, the audio devices 500 may receive the first charging power (e.g., a normal charging power) from the charging device 600, and may perform the charging to correspond to the first charging power. The audio devices 500 may make a request to the charging device 600 for the second charging power (e.g., a high-speed charging power) that is greater than the first charging power, which is used for the normal charging, through the communication with the charging device 600. Accordingly, the audio devices 500 may be supplied with the power corresponding to the second charging power from the charging device 600. The audio devices 500 may perform high-speed charging by using the second charging power supplied from the charging device 600. If the second charging power, which has been requested, is not supplied, the audio devices 500 may perform the normal charging by using the power (e.g., the first charging power) supplied from the charging device 600.

According to an embodiment of the present disclosure, the audio devices 500 may include a PMIC, a charger IC, or the like. For example, the PMIC may be mounted in an IC or a SoC. The PMIC may include a charger IC. The charger IC may include a charger IC for the wireless charging method. The wireless charging method, for example, may include an electromagnetic resonance method, a magnetic induction method, or an electromagnetic wave method, and additional circuits for the wireless charging (such as a coil loop, a resonance circuit, or a rectifier) may be added.

In an embodiment of the present disclosure, examples of performing the operation according to the battery charging level of the audio devices 500 are described below in detail with reference to the accompanying drawings.

In an embodiment of the present disclosure, the charging device 600 may include one or more batteries, and may include a charging circuit for charging the audio devices 500 (e.g., the first audio device 510 or the second audio device 520). The charging device 600 may be configured to include a coil for wireless charging. if the direct current (DC) power is supplied from the power supply device (e.g., a travel adapter (TA) or a power supply), the charging device 600 may convert the DC power into alternating current (AC) power, and may transmit the power to the audio devices 500 through an electrical circuit (e.g., a charging terminal or a transmission coil for wireless charging). The power supply device may be integrally included in the charging device 600, or may be implemented to be a separate device (e.g., a charger).

In an embodiment of the present disclosure, the charging device 600 may include a housing (or a body) 650, and the housing 650, for example, may include a communication circuit, a power interface, a control circuit, a battery, and at least one coupling recess (e.g., a fixing member) that is configured to accept the audio devices 500.

According to an embodiment of the present disclosure, the charging device 600 may control the power supply device to supply the first voltage (e.g., a reference voltage of 5V) or the second voltage (e.g., a high voltage of 10V), which is greater than the first voltage. For example, if the charging device 600 detects the connection of the power supply device, the charging device 600 may control the power supply device to output the first voltage, and thereafter, may control the power supply device to output the second voltage in response to a request of the audio devices 500. The charging device 600 may control the power supply device to gradually change the maximum voltage to a low voltage to then be supplied. For example, if a connection of the power supply device is detected, the charging device 600 may control the power supply device to output the second voltage (e.g., the maximum voltage of 10V), and thereafter, may control the power supply device to output a third voltage (e.g., 7V), which is less than the second voltage, in response to a request of the audio devices 500. The third voltage may be greater than the first voltage and less than the second voltage. The charging device 600 may control the output power of the power supply device based on information (e.g., power information) related to the charging power (e.g., the charging voltage and the charging current) that is required by the audio devices 500.

According to an embodiment of the present disclosure, the charging device 600 may configure a high-speed charging mode or a normal charging mode depending on whether or not the power supply device supports the high-speed charging. The charging device 600 may receive a variety of information about the ID of the power supply device or the type thereof from the power supply device. The charging device 600 may determine whether or not the power supply device supports the high-speed charging mode by using the received information. If the power supply device supports the high-speed charging mode, the charging device 600 may configure the charging mode to be the high-speed charging mode.

For example, the charging device 600 may determine whether or not the power supply device supports the high-speed charging mode according to signals that are received from the power supply device (e.g., signals of a D+ line and a D− line). The power supply device may transmit signals (e.g., signals of a D+ line and a D− line) that have different specific values (e.g., voltage values) depending on whether or not the power supply device supports the high-speed charging mode. The charging device 600 may determine whether or not the connected power supply device supports the high-speed charging mode based on the signals of the D+ line and the D− line, which are received from the power supply device.

According to an embodiment of the present disclosure, if the charging device 600 receives the charging power for the high-speed charging of the audio devices 500, the charging device 600 may configure the charging mode of the power supply device to be the high-speed charging mode. For example, the charging device 600 may transmit a signal corresponding to the charging power of the audio devices 500 to the power supply device, and may receive the same signal as the signal transmitted from the power supply device as a confirmation message. The charging device 600 may determine, through the confirmation message, that the power supply device can support the high-speed charging mode and can supply the power (output power) corresponding to the transmitted charging power.

According to an embodiment of the present disclosure, the charging device 600 may receive a request for the second charging power that is greater than the first charging power through communication with the audio devices 500. The charging device 600 may transfer the second charging power to the power supply device through communication with the power supply device, and may control the power supply device to supply the second charging power. For example, the charging device 600 may make a control to make a request to the power supply device for the output voltage greater than the normal charging power for the audio devices 500 and to receive the output voltage greater than the normal charging power from the power supply device.

According to an embodiment of the present disclosure, the charging device 600 may determine whether or not the output voltage is supplied from the power supply device. The charging device 600 may provide the audio devices 500 with the second voltage (e.g., 10V) that is provided from the power supply device. The charging device 600 may provide the audio devices 500 with the first voltage (e.g., 5V) that is provided from the power supply device.

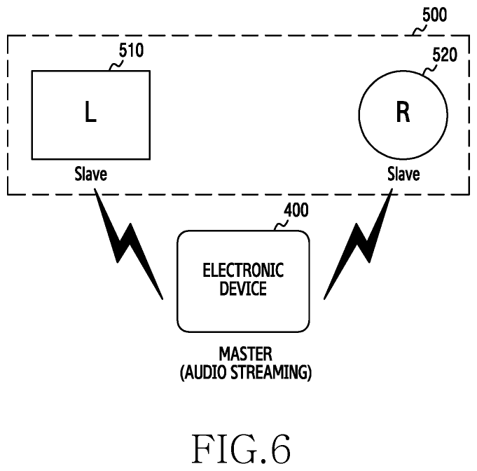

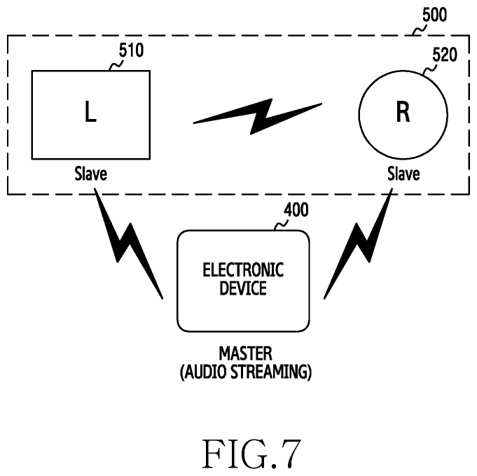

FIGS. 6 and 7 are diagrams of an electronic device 400 and an audio devices 500 in a system, according to an embodiment of the present disclosure.

Referring to FIG. 6, the electronic device 400 and the audio devices 500 are multi-paired. For example, the electronic device 400 may be simultaneously connected (paired) with the first audio device 510 and the second audio device 520, respectively. The electronic device 400 may register and manage the first audio device 510 (e.g., the left earpiece (EP_L)) and the second audio device 520 (e.g., the right earpiece (EP_R)) as one audible device in the audio devices 500.

Upon multi-pairing the electronic device 400 and the audio devices 500, the electronic device 400 may operate as a master device for audio streaming, and the audio devices 500 (e.g., the first audio device 510 and the second audio device 520) may operate as a slave device for the electronic device 400. The electronic device 400 may separate audio streaming for the first audio device 510 and the second audio device 520 (e.g., left audio streaming and right audio streaming) to then be transmitted to the first audio device 510 and the second audio device 520, respectively.

In an embodiment of the present disclosure, the electronic device 400 may simultaneously or sequentially receive information (e.g., the first information and the second information) that is related to the battery charging level from the first audio device 510 and the second audio device 520, respectively, and may compare the voltage of the first audio device 510 to the voltage of the second audio device 520 based on the received information. The electronic device 400 may give priority for performing the second function to the audio device having a high voltage (e.g., the first audio device 510) to then perform the second function. The electronic device 400 may control the audio device having a low voltage (e.g., the second audio device 520) to operate in a standby state (e.g., a sleep state) in order to thereby minimize the current consumption.

Referring to FIG. 7, FIG. 7 illustrates an example of multi-pairing the electronic device 400 and the audio devices 500, according to an embodiment of the present disclosure. For example, the electronic device 400 may be connected to the audio device (e.g., the first audio device 510) that operates as a master among the first audio device 510 and the second audio device 520 of the audio devices 500, and the first audio device 510 may be connected (paired) with the second audio device 520. The electronic device 400 may register and manage the first audio device 510 (e.g., the left earpiece (EP_L)) and the second audio device 520 (e.g., the right earpiece (EP_R)) as one audible device of the audio devices 500, and may connect to one audio device that operates as a master among the first audio device 510 and the second audio device 520. The first audio device 510 and the second audio device 520 may register and manage the counterpart audio device, respectively, and may configure the role of a master or a slave between the first audio device 510 and the second audio device 520 through signal communication therebetween.

if pairing the electronic device 400 with the audio devices 500 (e.g., the first audio device 510), the electronic device 400 may operate as a master device for audio streaming, and may transmit an audio stream to one of the audio devices 500 (e.g., the first audio device 510), which is connected (paired) while operating as a master among the audio devices 500. One of the audible devices 500 (e.g., the first audio device 510), which is connected (paired) with the electronic device 400 while operating as a master among the audio devices 500, may operate as a slave device for the electronic device 400, and may operate as a master device for the other audio device (e.g., the second audio device 520) in order to thereby transmit some of the received audio streaming (e.g., audio streaming (e.g., the right audio stream) that is allocated to the second audio device 520 that operates as a slave) to the other audio device.

In an embodiment of the present disclosure, the first audio device 510, which operates as a master, may receive information on the battery charging level from the second audio device 520, which operates as a slave, and may compare the voltage of the first audio device 510 with the voltage of the second audio device 520 based on the received information. If it is determined that the voltage of the first audio device 510 is greater than the voltage of the second audio device 520, the first audio device 510 may operate as a master for the second audio device 520. If it is determined that the voltage of the first audio device 510 is less than the voltage of the second audio device 520, the first audio device 510 may transmit a control signal that enables the second audio device 520 to operate as a master, and may operate as a slave for the second audio device 520 (e.g., convert from a master to a slave).

Alternatively, the first audio device 510 may transmit, to the electronic device 400, information (e.g., the first information and the second information) that is related to the battery charging levels of the first audio device 510 and the second audio device 520, and the electronic device 400 may compare the voltage of the first audio device 510 to the voltage of the second audio device 520 based on the received information. The electronic device 400 may configure the audio device having a high voltage (e.g., the first audio device 510) to operate as a master, and may transmit, to the first audio device 510, a control signal according thereto. The first audio device 510 may operate as a master in response to the control signal of the electronic device 400, or may transmit the control signal in order for the second audio device 520 to operate as a master. The second audio device 520 may switch from a slave to a master in response to the control signal in order to be thereby connected (paired) with the electronic device 400.

Referring to FIGS. 6 and 7, in an embodiment of the present disclosure, the audio devices 500 (e.g., the first audio device 510 or the second audio device 520) may perform the first communication connection to the electronic device 400. The audio devices 500 may exchange data with the electronic device 400 through the first communication connection. For example, the audio devices 500 may configure audio filter information of the audio devices 500 through the electronic device 400. The audio devices 500 may perform data communication through a connection to other electronic devices or networks via the electronic device 400. The electronic device 400 may establish a second communication connection to another electronic device or network. The audio devices 500 may exchange data with the other electronic device or network by using the communication standard provided by the electronic device 400. For example, the audio devices 500 may establish the first communication connection to the electronic device 400 by means of short-range wireless communication, such as NFMI or BLE, and the electronic device 400 may establish the second communication connection to another electronic device or network (e.g., including a connection through a gateway) by means of WiFi communication or mobile communication (e.g., 3G or LTE). The audio devices 500 may perform data exchange with other electronic devices or networks by using the electronic device 400. For example, the audio devices 500 may receive audio data information of other electronic devices through the electronic device 400.

According to an embodiment of the present disclosure, the audio devices 500 may perform a third communication connection to another electronic device. For example, the audio devices 500 may support the standards to communicate with other electronic device or networks. The audio devices 500 may support a standard for telecommunication (e.g., 3G or LTE), and may connect to a base station by communication in order to thereby provide a phone-call function.

The system, according to an embodiment of the present disclosure, may be configured to include the electronic device 400 and the audio devices 500 (e.g., the first audio device 510 and the second audio device 520), and the priority for the user's scenario may be given to the audio device having the highest battery voltage among the audio devices 500 so that the simultaneous usage time of the two audio devices may increase. For example, since each audio device has a single battery, a method may be required, which maintains the balance for the batteries between two audio devices, in order for the user to listen to music in stereo. In listening to stereo music using two audio devices, the current consumption of the battery for each audio device may be controlled according to a priority in order to thereby maximize usage time of the audio devices 500.

An example of a voice call function is described below.

If the electronic device 400 detects a voice call input, the electronic device 400 may compare the voltage of the first audio device 510 with the voltage of the second audio device 520, and may determine the audio device having the highest voltage (or the non-operating audio device having the lowest voltage). The electronic device 400 may give priority for a voice call function to the audio device having the highest voltage (e.g., the first audio device 510). The electronic device 400 may transmit, to the first audio device 510, various signals (e.g., audio signals, control signals, or the like) that are related to a voice call according to the priority. The first audio device 510 may output audio signals through a speaker, and may further notify the user of the voice call through lamp-flickering or a vibration output. The second audio device 520 may enter a sleep state to minimize current consumption.

An example of a speech recognition function is described below.

When the electronic device 400 detects the initiation of a speech recognition operation by a user's request or by voice triggering, the electronic device 400 may determine the audio device having the highest voltage (e.g., the first audio device 510) among the first audio device 510 and the second audio device 520. The electronic device 400 may give priority for speech recognition to the first audio device 510 having the highest voltage. The electronic device 400 may control the first audio device 510 to wait for a voice input for speech recognition. The first audio device 510 may wait for a voice input, and if a voice input is detected through a microphone, the first audio device 510 may transmit, to the electronic device 400, a signal corresponding to the voice input. The first audio device 510 having the highest voltage may always be in an active state to receive a user's voice input, and the second audio device 520 having the lowest voltage may enter the sleep state.

An example of a stereo function is described below.

A user may wear the first audio device 510 and the second audio device 520 in order to thereby listen to music in stereo, which is reproduced in the electronic device 400. If the electronic device 400 determines an audio streaming transmission (or while the electronic device 400 transmits the audio stream) to the first audio device 510 and the second audio device 520, the electronic device 400 may determine the first audio device 510 and the second audio device 520. The electronic device 400 may determine whether or not the voltage of the first audio device 510 or the voltage of the second audio device 520 is less than a certain voltage (e.g., a reference voltage, 3.6V). For example, it is assumed that the voltage of the first audio device 510 is less than a certain voltage. If the first audio device 510 is less than a certain voltage, the electronic device 400 may control the sound quality of the audio stream for the first audio device 510. For example, the electronic device 400 may adjust the sound quality for the first audio device 510 to be less than the reference sound quality (e.g., 192 Kbps to 96 Kbps). The electronic device 400 may variously configure the sound quality level based on the voltage of the first audio device 510. According to the adjustment of the sound quality for the first audio device 510, if the voltage of the first audio device 510 and the voltage of the second audio device 520 later become equal, or similar, to each other, the electronic device 400 may maintain the corresponding sound quality based on the user's configuration (e.g., power-saving), or may restore the sound quality to the original sound quality (e.g., 96 Kbps to 192 Kbps). In terms of the power-saving of the audio devices 500, if the first audio device 510 and the second audio device 520 have the same, or similar, voltage, the electronic device 400 may maintain the sound quality for the first audio device 510, and may adjust the sound quality for the second audio device 520 to be low. As described above, the electronic device 400 may check the battery charging levels of the first audio device 510 and the second audio device 520 during stereo audio reproduction in order to thereby adjust the balance thereof.

An example of a health function for measuring biometric information of a user based on the audio devices 500 is described below.

According to an embodiment of the present disclosure, the audio devices 500 may measure biometric information (or exercise information), such as monitoring a user's heart rate (e.g., HRM) or a number of steps a user takes, in real time. For example, the audio devices 500 may include a variety of sensors (e.g., an HRM sensor, an acceleration sensor, a geomagnetic sensor, a GPS, or the like). The audio devices 500 may transmit, to the electronic device 400, biometric information of a user, which is measured in real time. if the electronic device 400 performs a health function for a user by interacting with the audio devices 500, the electronic device 400 may control the audio device which has the highest voltage (e.g., the first audio device 510) among the first audio device 510 and the second audio device 520, to measure (e.g., an HRM measurement) biometric information of the user, and may control the second audio device 520 to enter the sleep state. Alternatively, the electronic device 400 may make a control to differently configure the biometric information measurement (e.g., an HRM measurement) ratios of the first audio device 510 having the highest voltage and the second audio device 520 having the lowest voltage. In addition, if the voltage of the first audio device 510 and the voltage of the second audio device 520 become equal or similar, the electronic device 400 may make a control to configure the biometric information measurement ratio of the first audio device 510 and the biometric information measurement ratio of the second audio device 520 to be the same. For example, the electronic device 400 may check the battery charging level of the first audio device 510 and the battery charging level of the second audio device 520, and may adjust the battery charging ratio between the first audio device 510 and the second audio device 520 to be n to 1 (e.g. n: 1), where n is a natural number, in order to thereby make a control to maintain the battery charging level (voltage level) of the first audio device 510 and the battery charging level of the second audio device 520 to be similar.

According to an embodiment of the present disclosure, the electronic device 400 may change the waiting cycles of various sensors that are provided in the first audio device 510 and the second audio device 520 according to the battery charging levels of the first audio device 510 and the second audio device 520. For example, the electronic device 400 may change the cycles of sensors (e.g., a barometer, an accelerometer, a touch sensor, or the like) of the audio device which has the lowest voltage. Alternatively, the electronic device 400 may control sensors to identify a state instead of making a measurement. Provided that a touch input for an operation control is received through the audio devices 500, the output data rate (ODR) of a certain module (e.g., a touch sensor) may be changed. For example, a touch sensor of only the audio device having the highest voltage (e.g., the first audio device 510) may be controlled to operate. In addition, the ODR of the audio device having the highest voltage (e.g., the first audio device 510) may be controlled for each mode. For example, a frequency of operation may be configured to be 1 Hz in a waiting state of the first audio device 510, and 10 Hz if a certain event (e.g., call reception) occurs.

In addition, although the operation in which the electronic device 400 adjusts the balancing according to the battery charging level of the audio devices 500 has been described as an example above, the present disclosure is not limited thereto. For example, one audio device, which operates as a master among the first audio device 510 and the second audio device 520, may process the aforementioned control operation performed by the electronic device 400.

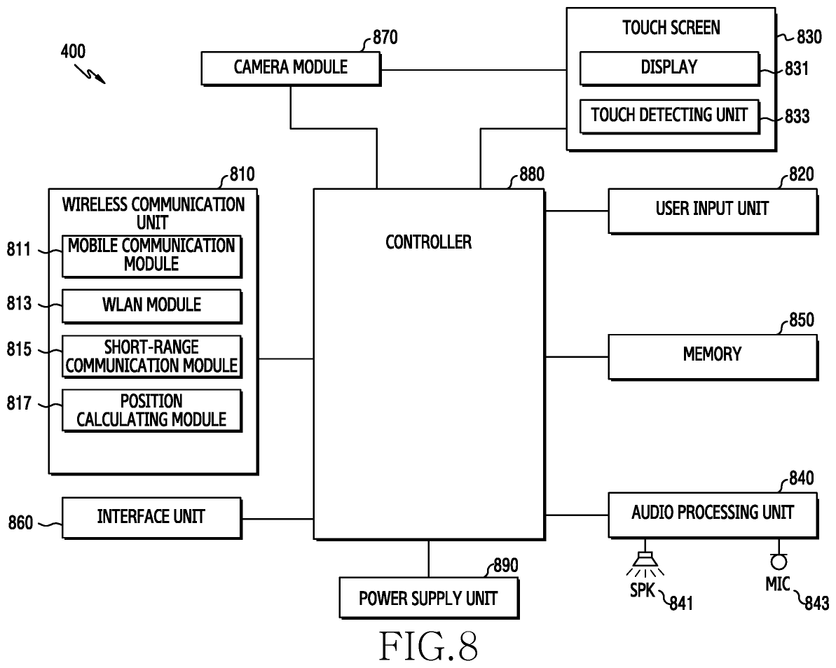

FIG. 8 is a block diagram of an electronic device, according to an embodiment of the present disclosure.

Referring to FIG. 8, the electronic device 400 may include, for example, a wireless communication unit 810, a user input unit 820, a touch screen 830, an audio processing unit 840, a memory 850, an interface unit 860, a camera module 870, a controller 880 (e.g., the processor 120), and a power supply unit 890. In an embodiment of the present disclosure, some of the elements shown in FIG. 8 may not be essential, and the electronic device 400 may be implemented to have more, or fewer, elements than the number of elements shown in FIG. 8.

The wireless communication unit 810, for example, may have the same, or a similar, configuration as the communication module 220 of FIG. 2. The wireless communication unit 810 may include one or more modules that enable wireless communication between the electronic device 400 and external electronic devices (e.g., the audio devices 500 or the server 106). For example, the wireless communication unit 810 may be configured to include a mobile communication module 811, a wireless local area network (WLAN) module 813, a short-range communication module 815, and a position calculating module 817. The wireless communication unit 810 may include a module (e.g., a short-range communication module, a telecommunication module, or the like) for performing communication with an external electronic devices.

The mobile communication module 811, for example, may have the same, or a similar, configuration as the cellular module 221 of FIG. 2. The mobile communication module 811 may transmit/receive wireless signals to/from at least one of a base station in the mobile communication network; external devices (e.g., the audio devices 500 or the other electronic device 104); or various servers (e.g., an application server, a management server, an integration server, a provider server, a content server, an Internet server, or a cloud server). Wireless signals may include voice signals, data signals, or various types of control signals. The mobile communication module 811 may transmit a variety of data that is necessary for the operation of the electronic device 400 to external devices (e.g., the audio devices 500, the server 106, or the other electronic device 104) in response to a user's request.

The WLAN module 813, for example, may have the same, or a similar, configuration as the WiFi module 223 of FIG. 2. The WLAN module 813 may refer to a module for wireless Internet access and for forming WLAN links with other external electronic devices (e.g., the audio devices 500, the other electronic device 102, or the server 106). The WLAN module 813 may be internal, or external, to the electronic device 400. Wireless Internet technology may use WiFi, wireless broadband (Wibro), world interoperability for microwave access (WiMax), high speed downlink packet access (HSDPA), or millimeter wave mmWave). The WLAN module 813 may interact with other external electronic devices (e.g., the audio devices 500 or the other electronic device 104), which are connected with the electronic device 400 through a network (e.g., a wireless Internet network) (e.g., the network 162) in order to thereby transmit a variety of data of the electronic device 400 to an external device (e.g., the audio devices 500), or in order to thereby receive data from an external device. The WLAN module 813 may always be in an on, state, or may be turned on/off according to a configuration of the electronic device 400 or a user input.

The short-range communication module 815 may refer to a module for performing short-range communication. The short-range communication technology may be Bluetooth, BLE, radio frequency identification (RFID), an IrDA standard, ultra wideband (UWB), ZigBee, NFMI, or NFC. The short-range communication module 815 may interact with other external electronic devices (e.g., the audio devices 500), which are connected with the electronic device 400 through a network (e.g., a short-range communication network) in order to thereby transmit a variety of data of the electronic device 400 to the external electronic devices, or in order to thereby receive data from the same. The short-range communication module 815 may always be in an on state, or may be turned on/off according to a configuration of the electronic device 400 or a user input.

The position calculating module 817, for example, may have the same, or a similar, configuration as the GNSS module 227 of FIG. 2. The position calculating module 817 obtains the position of the electronic device 400, and may include a GPS module. The position calculating module 817 may calculate the position of the electronic device 400 by triangulation.

The user input unit 820 may create input data for controlling the operation of the electronic device 400 in response to a user input. The user input unit 820 may include one or more input devices for detecting various inputs from a user. For example, the user input unit 820 may include a keypad, a dome switch, physical buttons, a touch pad (e.g., a pressure-sensitive type, a capacitive type), a jog and shuttle, and sensors (e.g., the sensor module 240).

Some of the user input unit 820 may be implemented in the form of a button on the outside of the electronic device 400, or some or all of the user input unit 820 may be implemented as a touch panel. The user input unit 820 may receive a user input for initiating an operation of the electronic device 400 (e.g., an audio reproduction function, a connection function of the audio devices 500, or the like), according to an embodiment of the present disclosure, and may create an input signal in response to the user input.

The touch screen 830 may refer to an input/output device that may perform both an input function and a display function, and may include a display 831 (e.g., the display 160 or 260) and a touch detecting unit 833. The touch screen 830 may provide an input/output interface between the electronic device 400 and a user; transmit a user's touch input to the electronic device 400; and serve as a medium for displaying an output of the electronic device 400 to the user. The touch screen 830 may display a visual output to the user. The visual output may be made in the form of text, a graphic, a video, or a combination thereof.

The display 831 may display (output) a variety of information that is processed in the electronic device 400. For example, the display 831 may display a user interface (UT) or a GUI that is related to an operation of connecting to the audio devices 500 by the electronic device 400; displaying the battery level of the audio devices 500; or reproducing audio files. The display 831 may adopt various displays (e.g., the display 160). In an embodiment of the present disclosure, a bent display may be used for the display 831.

The touch detecting unit 833 may be placed on the display 831, and may detect a user input made by a touch or proximity event with respect to the surface of the touch screen 830. The user input may include a touch event or a proximity event, which is made based on at least one of a single-touch, a multi-touch, hovering, or an air gesture. The touch detecting unit 833, in various embodiments, may receive a user input for initiating an operation related to the usage of the electronic device 400, and may generate an input signal in response to the user input.

The audio processing unit 840, for example, may have the same, or a similar, configuration as the audio module 280 of FIG. 2. The audio processing unit 840 may perform a function of transmitting audio signals received from the controller 880 to a speaker (SPK) 841, and may perform a function of transmitting, to the controller 880, audio signals, such as voice, which is input from a microphone (MIC) 843. The audio processing unit 840 may convert voice/sound data into audible sounds in order to thereby output the same to the speaker 841, and may convert audio signals, such as a voice, which are received from the microphone 843, into digital signals in order to thereby transmit the same to the controller 880, according to the control of the controller 880.

The speaker 841 may output audio data, which is received from the wireless communication unit 810 or is stored in the memory 850. The speaker 841 may output sound in relation to various operations (functions), which are performed by the electronic device 400.

The microphone 843 may receive sound, and may convert the same to electrical sound data. The microphone 843 may have a variety of noise reduction algorithms to remove noise generated in the course of receiving sound. The microphone 843 may input an audio stream, such as a voice command (e.g., a voice command to initiate a function of selecting the audio devices 500; connecting to the audio devices 500; or reproducing audio data).

The memory 850 (e.g., the memory 130 or 230) may store one or more programs that are executed by the controller 880, and may perform a function of temporarily storing the input/output data. The input/output data, for example, may contain files (such as moving images, images, pictures, or audio files) and frequency information (channel information). The memory 850 may store data. The data, which is obtained in real time, may be stored in a temporary storage device, and data may be stored in a permanent storage device.

In an embodiment of the present disclosure, the memory 850 may store one or more programs, data, or instructions that are related to the operation in which the controller 880 (e.g., the processor): establishes connections with the first audio device 510 and the second audio device 520 by using the wireless communication circuit (e.g., the wireless communication unit 810); receives, from the first audio device 510, the first data that is related to the charging level of the first battery included in the first audio device 510 by using the wireless communication circuit; receives, from the first audio device 510 or the second audio device 520, the second data that is related to the charging level of the second battery included in the second audio device 520 by using the wireless communication circuit; and transmits, to at least one of the first audio device 510 or the second audio device 520, one or more control signals that enable the first audio device 510 and the second audio device 520 to operate differently from each other based on at least some of the first data or the second data.

According to an embodiment of the present disclosure, the memory 850 may store one or more programs, data, or instructions that are related to the operation of transmitting one or more control signals, to the first audio device 510, that enable the first audio device 510 to perform the second selected operation if it is determined that the charging level of the first battery is higher than the charging level of the second battery as a result of comparing the charging level of the first battery to the charging level of the second battery.

According to an embodiment of the present disclosure, the memory 850 may store one or more programs, data, or instructions that are related to the operation of transmitting one or more other control signals to the second audio device 520 that enable the second audio device 520 to perform the first selected operation.

According to an embodiment of the present disclosure, the memory 850, for example, may store one or more programs, data, or instructions that are related to the operations of transmitting, to the first audio device 510, one or more other control signals that enable the second audio device 520 to perform the first selected operation and a request for transmitting one or more other control signals to the second audio device 520; and transmitting, to the second audio device 520, one or more other control signals that enable the second audio device 520 to not perform the second selected operation.

According to an embodiment of the present disclosure, the memory 850 may store one or more programs, data, or instructions that are related to the operation of transmitting, to the external charging device 600 that is configured to supply the charging power to at least one of the first audio device 510 or the second audio device 520, one or more other control signals that enable the external charging device 600 to supply the charging power to the second audio device 520 prior to the first audio device 510 or at a high ratio if it is determined that the charging level of the first battery is higher than the charging level of the second battery as a result of comparing the charging level of the first battery with the charging level of the second battery.

According to an embodiment of the present disclosure, the memory 850 may store one or more programs, data, or instructions that are related to the operations of detecting a change in the corresponding charging level (e.g., inversion of the level) between the first audio device 510 and the second audio device 520; establishing a reconnection to the audio device having a high corresponding level according to the change in the corresponding charging level between the first audio device 510 and the second audio device 520; and transmitting one or more control signals to the reconnected audio device.

The memory 850 may include one or more application modules (or software modules).

The interface unit 860, for example, may have the same, or a similar, configuration as the interface 270 of FIG. 2. The interface unit 860 may receive data or power from other electronic devices in order to thereby transmit the same to the elements in the electronic device 400. The interface unit 860 may enable data in the electronic device 400 to be transmitted to other electronic devices. For example, the interface unit 860 may include a wired/wireless headset port, an external charger port, a wired/wireless data port, a memory card port, an audio input/output port, a video input/output port, an earphone port, or the like.

The camera module 870 (e.g., the camera module 291) may support a photographing function of the electronic device 400. The camera module 870 may photograph a certain subject in order to thereby transmit the photographed data (e.g., images) to the display 831 and the controller 880 under the control of the controller 880.

The controller 880 (e.g., the processor or the control circuit) may control the overall operations of the electronic device 400. In an embodiment of the present disclosure, the controller 880, for example, may have the same, or a similar, configuration as the processor 210 of FIG. 2. The controller 880 may process operations of establishing connections with the first audio device 510 and the second audio device 520 by using the wireless communication circuit (e.g., the wireless communication unit 810); receiving, from the first audio device 510, the first data that is related to the charging level of the first battery included in the first audio device 510 by using the wireless communication circuit; receiving, from the first audio device 510 or the second audio device 520, the second data that is related to the charging level of the second battery included in the second audio device 520 by using the wireless communication circuit; and transmitting, to at least one of the first audio device 510 or the second audio device 520, one or more control signals that enable the first audio device 510 and the second audio device 520 to operate differently from each other based on at least some of the first data or the second data.

The controller 880 may include one or more processors for controlling the operation of the electronic device 400. In an embodiment of the present disclosure, the controller 880 may control the operation of hardware modules, such as the audio processing unit 840, the interface unit 860, or the display 831. The control operation of the controller 880 is described below n detail with reference to the accompanying drawings. The controller 880 may be implemented by one or more processors that control the operation of the electronic device 400 by executing one or more programs, which are stored in the memory 850.

The power supply unit 890 may receive power from an external or internal power source in order to thereby supply power that is necessary for the operation of the elements under the control of the controller 880. In an embodiment of the present disclosure, the power supply unit 890 may supply power to the display 831 or the camera module 870, or may cut off the supply of power thereto under the control of the controller 880.

As described above, the electronic device 400, according to various embodiments of the present disclosure, may include a wireless communication circuit; a processor configured to be electrically connected to the wireless communication circuit; and a memory configured to be electrically connected to the processor, wherein the memory stores instructions that, if executed, enable the processor to establish a connection to a first earpiece and a second earpiece by using the wireless communication circuit; receive, from the first earpiece, the first data that is related to the charging level of the first battery included in the first earpiece by using the wireless communication circuit; receive, from the first earpiece or the second earpiece, the second data that is related to the charging level of the second battery included in the second earpiece by using the wireless communication circuit; and transmit, to at least one of the first earpiece or the second earpiece, one or more control signals that enable the first earpiece and the second earpiece to operate differently from each other based on at least some of the first data and the second data.

According to an embodiment of the present disclosure, the processor may transmit, to the first earpiece, one or more control signals that enable the first earpiece to perform the second selected operation if it is determined that the charging level of the first battery is greater than the charging level of the second battery as a result of comparing the charging level of the first battery to the charging level of the second battery.

According to an embodiment of the present disclosure, the processor may be configured to transmit, to the second earpiece, one or more other control signals that enable the second earpiece to perform the first selected operation. The first selected operation may include an audio streaming output, and the second selected operation may include at least one of call reception, user's voice reception, charging, activation of a sensor, or an audio signal output of a selected sound quality.

According to an embodiment of the present disclosure, the processor may be configured to transmit, to the first earpiece, one or more other control signals that enable the second earpiece to perform the first selected operation and a request for transmitting the one or more other control signals to the second earpiece. The processor may be configured to transmit, to the second earpiece, one or more other control signals that enable the second earpiece to not perform the second selected operation.

According to an embodiment of the present disclosure, the processor may be configured to transmit, to an external charging device configured to supply charging power at least one of the first earpiece or the second earpiece, one or more other control signals that enable the external charging device to supply charging power to the second earpiece prior to the first earpiece or at a higher ratio than that of the first earpiece if the charging level of the first battery is determined to be greater than the charging level of the second battery as a result of comparing the charging level of the first battery to the charging level of the second battery.

According to an embodiment of the present disclosure, the processor may be configured to detect a change in the corresponding charging level between the first earpiece and the second earpiece; establish a reconnection to the earpiece having a high corresponding level according to the change in the corresponding charging level between the first earpiece and the second earpiece; and transmit the one or more control signals to the reconnected earpiece.

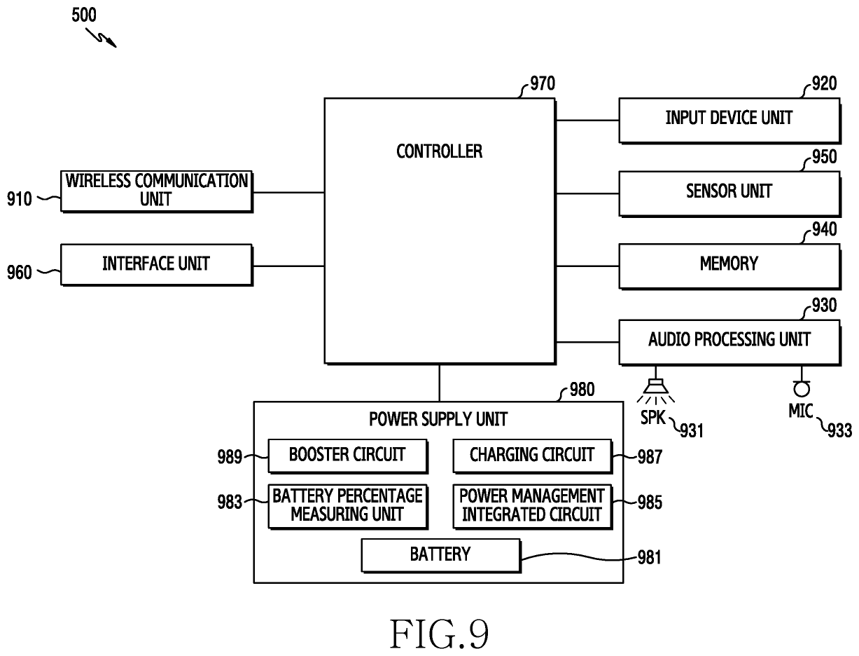

FIG. 9 is a block diagram of audio devices 500, according to an embodiment of the present disclosure.

Referring to FIG. 9, the audio devices 500 may include a wireless communication unit 910, an input device unit 920, an audio processing unit 930, a memory 940, a sensor unit 950, an interface unit 960, a controller 970, and a power supply unit 980, and the audio devices 500 may have the same, or a similar, configuration as the electronic device 400 of FIG. 8 described above. In an embodiment of the present disclosure, all of the elements shown in FIG. 9 may not be essential, so the audio devices 500 may be implemented to have more, or fewer, elements than the elements shown in FIG. 9.

The wireless communication unit 910 may include one or more modules that enable wireless communication between the audio devices 500 and other external electronic devices (e.g., the electronic device 400). For example, the wireless communication unit 910 may be configured to include a short-range communication module, and may further include communication modules corresponding to the wireless communication unit 810 of FIG. 8. The wireless communication unit 910 may include a module (e.g., a short-range communication module, a telecommunication module, or the like) for performing communication with external electronic devices. The configuration of the wireless communication unit 910 may correspond to the configuration of the wireless communication unit 810, which is described above with reference to FIG. 8, so the detailed description thereof is omitted here.

The input device unit 920 may create input data for controlling the operation of the audio devices 500 in response to a user input. The configuration of the input device unit 920 may correspond to the configuration of the user input unit 820, which is described above with reference to FIG. 8, so the detailed description thereof is omitted here.

The audio processing unit 930 may perform functions of transmitting, to a speaker (SPK) 931, audio signals, which are received from external electronic devices (e.g., the electronic device 400) through the wireless communication unit 910; and transferring, to the controller 970, audio signals, such as voice, which is input from a microphone (MIC) 933 under the control of the controller 970. The configuration of the audio processing unit 930 may correspond to the configuration of the audio processing unit 940, which is described above with reference to FIG. 8 above, so the detailed description thereof is omitted here.

The memory 940 (e.g., the memory 120 or 230) may store one or more programs that are executed by the controller 970, and may perform a function of temporarily storing the input/output data. The input/output data, for example, may contain audio streaming, voice instructions, mode configuration information, or the like. The memory 940 may store obtained data. The data, which is obtained in real time, may be stored in a temporary storage device, and the data, which is stored, may be stored in a permanent storage device.

In an embodiment of the present disclosure, the memory 940 may store one or more programs, data, or instructions that are related to an operation in which the controller 970 (e.g., the processor): establishes a connection to the electronic device 400 or the other audio device by using the communication circuit (e.g., the wireless communication unit 910 or the interface unit 960); receives, from the electronic device 400, the first control information that enables the audio device, or the audio device and the other audio device, to perform the first selected operation and the second control information that enables the audio device to perform the second selected operation or disables the other audio device to not perform the second selected operation by using the communication circuit; enables the audio device to perform the first selected operation based on the first control information; and transmits the first control information or the second control information to the other audio device by using the communication circuit.

According to an embodiment of the present disclosure, the memory 940 may store one or more programs, data, or instructions that are related to the operations of establishing connections with the electronic device 400 and the other audio device by using the communication circuit; detecting the charging level of the first battery in order to thereby create the first data; receiving, from the other audio device, the second data that is related to the charging level of the second battery included in the other audio device; and transmitting, to the other audio device, one or more control signals for controlling the other audio device based on at least some of the first data and the second data.

According to an embodiment of the present disclosure, the memory 940 may store one or more programs, data, or instructions that are related to the operation of transmitting, to the electronic device, information based on the first data and the second data.

According to an embodiment of the present disclosure, the memory 940 may store one or more programs, data, or instructions that are related to the operations of establishing connections with the electronic device 400 and the other audio device by using the communication circuit; detecting the charging level of the second battery in order to thereby create the second data; transmitting the second data created to at least one of the electronic device or the other audio device; receiving, from the electronic device or the other audio device, one or more control signals that enable the audio device to perform a selected operation; and performing the selected operation based on at least one control signal.

The memory 940 may include one or more application modules (or software modules).

The sensor unit 950 may have the same, or a similar, configuration as the sensor module 240 of FIG. 2. In an embodiment of the present disclosure, the sensor unit 950 may detect the movement and position of the audio devices 500, and may provide the controller 970 with sensed information according to the detection result. The sensor unit 950 may include one or more sensors that may detect whether or not the audio devices 500 is worn on the user's body and may create data to be used to determine the wearing state or the non-wearing state. In various embodiments, the one or more sensors, for example, may include at least one of an HRM sensor, a proximity sensor, a biometric sensor, a gyro sensor, an acceleration sensor, an angular velocity sensor, a GPS sensor, a speech recognition sensor, a wind (noise) measurement sensor, or a rotation recognition sensor. The audio devices 500 (e.g., the controller 970) may identify whether or not the audio devices 500 are worn on a user through the sensor unit 950. The audio devices 500 may determine whether or not the audio devices 500 are worn on a user in order to thereby configure the power control mode of the audio devices 500. The audio devices 500 may detect the motion of a user using an acceleration sensor, and if motion is not detected, the audio devices 500 may operate in the sleep mode. The audio devices 500 may identify whether or not a user's heart rate is detected through the user's ears using an HRM sensor, and if no heart rate is detected, the audio devices 500 may operate in the sleep mode.

The interface unit 960 may have the same, or a similar, configuration as the interface 270 of FIG. 2. The interface unit 960 may receive data or power from other external electronic devices in order to thereby transfer the same to the elements in the audio devices 500. The interface unit 960 may enable data in the audio devices 500 to be transmitted to other external electronic devices (e.g., the electronic device 400). The configuration of the interface unit 960 may correspond to the configuration of the interface unit 860, which is described above with reference to FIG. 8.

The controller 970 (e.g., the processor or the control circuit) may control the overall operations of the audio devices 500. In an embodiment of the present disclosure, the controller 970 may have the same, or a similar, configuration as the processor 210 of FIG. 2. The controller 970 may process operations of: establishing a connection to the electronic device 400 or the other audio device using the communication circuit (e.g., the wireless communication unit 910); receiving, from the electronic device 400, the first control information that enables the audio device, or the audio device and the other audio device, to perform the first selected operation, and the second control information that enables the audio device to perform the second selected operation or disables the other audio device to not perform the second selected operation by using the communication circuit; perform the first selected operation in the audio device based on the first control information; and transmitting the first control information or the second control information to the other audio device by using the communication circuit.

According to an embodiment of the present disclosure, the controller 970 may process operations of establishing connections with the electronic device and the other audio device by using the communication circuit; detecting the charging level of the first battery in order to thereby create the first data; receiving, from the other audio device, the second data that is related to the charging level of the second battery included in the other audio device; and transmitting, to the other audio device, one or more control signals for controlling the other audio device based on at least some of the first data and the second data.

According to an embodiment of the present disclosure, the controller 970 may process operations of establishing connections with the electronic device 400 and the other audio device by using the communication circuit; detecting the charging level of the second battery in order to thereby create the second data; transmitting the second data created to at least one of the electronic device or the other audio device; receiving, from the electronic device 400 or the other audio device, one or more control signals that enable the audio device to perform a selected operation; and performing the selected operation based on one or more control signals.

The controller 970 may include one or more processors for controlling the operation of the audio devices 500. In an embodiment of the present disclosure, the controller 970 may control the operation of hardware modules, such as wireless communication unit 910, the audio processing unit 930, the sensor unit 950, or the interface unit 960. The control operation of the controller 970 is described below in detail with reference to the accompanying drawings. The controller 970 may be implemented by one or more processors that control the operation of the audio devices 500 by executing one or more programs, which are stored in the memory 940.

The power supply unit 980 may receive power from an external power source or an internal power source in order to thereby supply power that is necessary for the operation of the elements under the control of the controller 970. In an embodiment of the present disclosure, the power supply unit 980 may supply power to the wireless communication unit 910, the sensor unit 950, or the audio processing unit 930, or may cut off the supply of power thereto under the control of the controller 970.

According to an embodiment of the present disclosure, the power supply unit 980, for example, may include a battery control circuit. For example, the power supply unit 980 may be configured to include a battery 981, a battery percentage measuring unit 983, a PMIC 985, a charging circuit 987, and a booster circuit 989.

The battery 981 may be functionally, or physically, connected to the audio devices 500 through various interfaces. For example, the battery 981 may include a rechargeable battery and/or a solar cell.

The battery percentage measuring unit 983 (e.g., a power gauge) may measure information on the battery 981. According to an embodiment of the present disclosure, the information on the battery 981 may contain the remaining amount, a charging voltage, current, or temperature of the battery 981. The battery percentage measuring unit 983 may measure the information on the battery 981 based on a signal that is received through an electrical path connected to the battery 981. The battery percentage measuring unit 983 may provide the measured information on the battery 981 to the controller 970.

The PMIC 985 may manage the power of the audio devices 500. The PMIC 985 may include a wired and/or wireless charging system. In an embodiment of the present disclosure, the wireless charging system, for example, may use a magnetic resonance method, a magnetic induction method, or an electromagnetic radiation method, and may further include additional circuits (such as a coil loop, a resonance circuit, or a rectifier) for wireless charging.

The charging circuit 987 may provide a voltage, which is applied through the booster circuit 989 or an external device (e.g., a charger), to at least one of the PMIC 985 or the battery 981.

The booster circuit 989 may be connected to the battery 981 in order to thereby boost the voltage of the connected battery and then provide the same to the charging circuit 987.

In an embodiment of the present disclosure, the audio devices 500 may communicate with other electronic devices (e.g., the electronic device 400, such as a smart phone or a tablet PC). The audio devices 500 may be paired with other electronic devices through wireless communication (e.g., RF, NFMI, BT, BLE, or the like). For example, the audio devices 500 may receive, from the connected electronic device 400, a music reproduction signal, a call reception signal, an alarm signal, or microphone input signals of the electronic device 400, and may output the same as sound information.

The audio devices 500 may change the configuration state of the audio devices 500 through the other electronic devices. The audio devices 500 may be small and may not have a separate display device. Furthermore, the audio devices 500 may be comprised of a limited input unit (e.g., buttons). For example, if configuring the mode or volume through the input unit of the audio devices 500, it may be inconvenient to check the configuration state and to configure a desired mode. For example, if the volume level is changed from 3 to 2 by using a button, the button may be pressed four times (e.g., 3→4→5→1→2). Various modes of the audio devices 500 may be conveniently configured if it is configured in association with the other electronic device. For example, in the case of using the electronic device 400 that includes a variety of input units (e.g., touch keys or buttons) and a display device, a UI may be provided to a user through the electronic device 400 so that the user may easily change the configuration of the audio devices 500 according to the provided UI. The mode may be configured through a touch input (e.g., a one-time touch input) if adjusting the volume.

For example, the audio devices 500 may communicate with the electronic device 400 in order to thereby process the control and change of the configuration of the audio devices 500. According to an embodiment of the present disclosure, a configuration application related to the audio devices 500 may be provided to the electronic device 400, and the mode control and volume control of the audio devices 500 may be processed through the configuration application. The user may display modes that may be configured in the audio devices 500 through a display of the electronic device 400, and may configure a desired mode through an input device (e.g., a touch screen) of the electronic device 400. The volume of the audio devices 500 may be adjusted through an input unit (e.g., a volume key) of the electronic device 400. In addition, the mode of the audio devices 500 may be configured through various sensors (e.g., an acceleration sensor, a gyro sensor, a biometric sensor, a proximity sensor, or the like) of the electronic device 400 that is connected with the audio devices 500. According to an embodiment of the present disclosure, the configured mode of the audio devices 500 may be changed by rocking the electronic device 400 left and right, or up and down.

The audio devices 500 may be connected to the electronic device 400 in order to thereby output the sound of a remote place clearly. For example, the user may reproduce and listen to sound sources that are recorded in the electronic device 400 through the audio devices 500. If the input unit (e.g., a microphone) of the electronic device 400 is configured to be a remote microphone, the audio devices 500 may receive audio signals of the microphone of the electronic device 400. The audio signals of the microphone, which are received from the electronic device 400, may be processed into compressed data through a data compression operation, and the compressed data may be transmitted to the audio devices 500 through the wireless communication unit of the electronic device 400. The audio devices 500 may receive the data through the wireless communication unit of the audio devices 500; separate audio information that is contained in the data format; and reproduce the same through an audio information decompression operation to then be output to a receiver.

The audio devices 500 may receive audio signals that are stored in the electronic device 400 in order to thereby reproduce the same. The electronic device 400 may store a number of alarm sounds. For example, the electronic device 400 may transmit, to the audio devices 500, different alarm sounds depending on the user's situation, and the state of a system, time, reception or non-reception of a message, or reception or non-reception of an e-mail to then be reproduced. The audio devices 500 may separate audio information, which is contained in the data format, from the data that is transmitted from the electronic device 400, and may reproduce the same through the audio information decompression operation to then be output to the receiver.

The audio devices 500 may record signals by using the electronic device 400. For example, the audio data may be stored after being compressed for effective use by the electronic device 400. The electronic device 400 may convert the audio signal, which is received from the audio devices 500, into text information by using speech-to-text (STT)) technology to then be stored. The electronic device 400 may store text corresponding to a conversation, voice mails of the user, or the content of a broadcast by using the STT method. The electronic device 400 may add and store a variety of information, such as time information, sensor information, or location information if storing text corresponding to a conversation, voice mails of a user, or content of a broadcast. In an embodiment of the present disclosure, the conversation stored in the electronic device 400 may be viewed by using the display of the electronic device 400. Alternatively, the electronic device 400 may convert the text information into audio signals by using text-to-speech (TTS) technology to then be transmitted to the receiver of the audio devices 500.

The audio devices 500 may transmit signals that are received through the microphone, which is provided in the audio devices 500, to the electronic device 400, and the electronic device 400 may store the received signals. In order to reduce the power consumption for transmitting the signals received through the microphone of the audio devices 500 to the electronic device 400, the data signals may be compressed, and then the compressed signals may be transmitted. The audio devices 500 may include a codec for compressing, or decompressing, the audio data. The signal received through the microphone of the audio devices 500 may be transmitted to the electronic device 400, and may be converted into text information through the STT technology to then be stored. The stored text may be output through the speaker of the electronic device 400.

According to an embodiment of the present disclosure, the audio devices 500 and the electronic device 400 may be used as a communication means between remote places by using the microphone and the receiver.

As described above, the audio devices 500, according to various embodiments, may include a housing configured to include a portion that is detachably mounted on a user's ear; a speaker configured to be included in the housing; a first battery configured to be included in the housing; one or more wireless communication circuits configured to be included in the housing; a processor configured to be included in the housing and configured to be electrically connected to the wireless communication circuit; and a memory configured to be included in the housing and configured to be electrically connected to the processor, wherein the processor is configured to establish a connection to an electronic device or the other audio device by using the wireless communication circuit; receive, from the electronic device, the first control information that enables the audio device, or the audio device and the other audio device, to perform the first selected operation and the second control information that enables the audio device to perform the second selected operation or enables the other audio device to not perform the second selected operation by using the communication circuit; enable the audio device to perform the first selected operation based on the first control information; and transmit the first control information or the second control information to the other audio device by using the communication circuit.

According to an embodiment of the present disclosure, the first selected operation may include an audio streaming output, and the second selected operation may include at least one of the call reception, the user's voice reception, the charging, the activation of a sensor, or an audio signal output of a selected sound quality.

The audio devices 500, according to an embodiment of the present disclosure, may include a housing configured to include a portion that is detachably mounted on the user's ear; a speaker configured to be included in the housing; a first battery configured to be included in the housing; one or more wireless communication circuits configured to be included in the housing; a processor configured to be included in the housing and configured to be electrically connected to the wireless communication circuit; and a memory configured to be included in the housing and configured to be electrically connected to the processor, wherein the processor is configured to establish connections with the electronic device and the other audio device by using the wireless communication circuit; detect the charging level of the first battery in order to thereby create the first data; receive, from the other audio device, the second data that is related to the charging level of the second battery included in the other audio device; and transmit, to the other audio device, one or more control signals for controlling the other audio device based on at least some of the first data and the second data.

According to an embodiment of the present disclosure, the control signal may contain control information that enables the other audio device to operate differently from the audio device. The processor may be configured to transmit, to the electronic device, information based on the first data and the second data.

The audio devices 500, according to an embodiment of the present disclosure, may include a housing configured to include a portion that is detachably mounted on a user's ear; a speaker configured to be included in the housing; a second battery configured to be included in the housing; a wireless communication circuit configured to be included in the housing; a processor configured to be included in the housing and configured to be electrically connected to the communication circuit; and a memory configured to be included in the housing and configured to be electrically connected to the processor, wherein the processor is configured to establish connections with an electronic device and the other audio device by using the wireless communication circuit; detect the charging level of the second battery in order to thereby create the second data; transmit the created second data to at least one of the electronic device or the other audio device; receive, from the electronic device or the other audio device, one or more control signals that enable the audio device to perform a selected operation; and enable the audio device to perform the selected operation based on the one or more control signals.

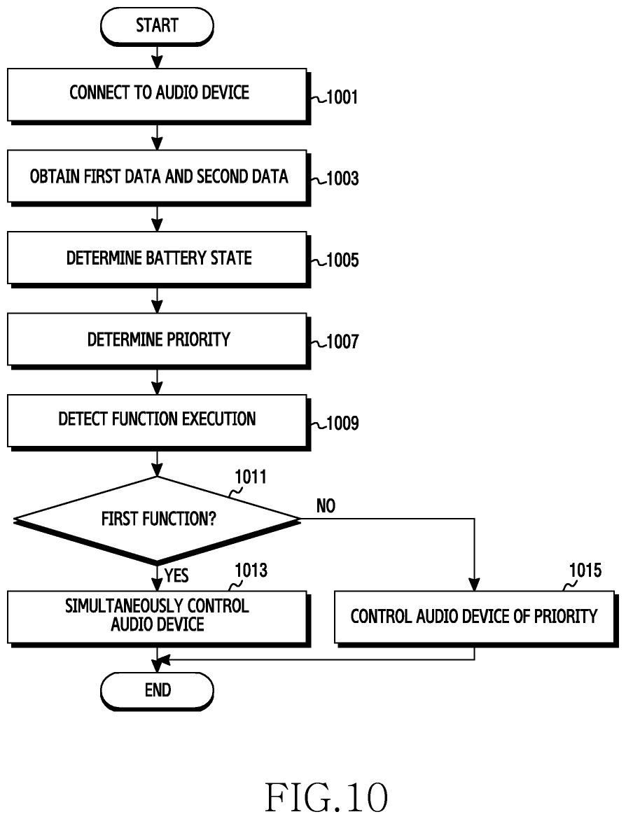

FIG. 10 is a flowchart of a method of an electronic device, according to an embodiment of the present disclosure.

Referring to FIG. 10, in step 1001, the controller 880 of the electronic device 400 may establish a connection to audio devices 500 (e.g., the first audio device 510 and the second audio device 520). For example, the electronic device 400 and the audio devices 500 may be connected in various ways depending on the operating system.

According to an embodiment of the present disclosure, the electronic device 400, for example, may establish a connection to the first audio device 510 that operates as a slave with respect to the electronic device 400 and operates as a master with respect to the other audio devices 500 among the audio devices 500. For example, the electronic device 400 and the first audio device 510 may be connected to each other by the first wireless communication, and the first audio device 510 and second audio device 520 may be connected to each other by the second wireless communication. In this case, the first audio device 510, which is connected to the electronic device 400 by the first wireless communication, may be a slave device with respect to the electronic device 400, and may be a master device with respect to the second audio device 520, which is connected by the second wireless communication. The second audio device 520, which is not connected to the electronic device 400, may be a slave device with respect to the first audio device 510, which is connected by the second wireless communication. The master/slave operation between the first audio device 510 and the second audio device 520 of the audio devices 500 may be pre-configured, and the electronic device 400 may establish a connection to the audio devices 500, which is configured to be a master, through the first wireless communication. The electronic device 400 may determine the audio device to which the electronic device 400 attempts to connect among the first audio device 510 and the second audio device 520. For example, the electronic device 400 may compare the state information (e.g., the channel state, the signal strength, or the battery charging level) of the first audio device 510 with the state information (e.g., the channel state, the signal strength, or the battery charging level) of the second audio device 520, and may determine the audio device that has better state information (e.g., a good channel state, a strong signal strength, or a high battery charging level) to be a master device in order to thereby attempt to connect thereto.

According to an embodiment of the present disclosure, in the case where the audio devices 500 operate as slaves with respect to the electronic device 400, the electronic device 400 may establish a connection to each of the first audio device 510 and the second audio device 520. The electronic device 400 and the audio devices 500 may be connected by the first wireless communication. In this case, the first audio device 510 and the second audio device 520, which are connected to the electronic device 400 through the first wireless communication, respectively, may be slave devices for the electronic device 400.

In an embodiment of the present disclosure, the first wireless communication and the second wireless communication may include wireless communication, such as BT, BLE, NFMI, or the like. The first wireless communication and the second wireless communication are not limited thereto, and may include a variety of other wireless communications, such as WiFi, NFC, ZigBee, UWB, or IrDA.

In step 1003, the controller 880 may obtain the first data and the second data from the connected audio devices 500. In various embodiments, the first data may contain data related to the charging level of the battery of the first audio device 510 (e.g., the remaining amount of the battery included in the first audio device 510, hereinafter referred to as the first charging level). The second data may contain data related to the charging level of the battery of the second audio device 520 (e.g., the remaining amount of the battery included in the second audio device 520, hereinafter referred to as the second charging level).

According to an embodiment of the present disclosure, the electronic device 400 may differently obtain the first data and the second data according to the connected audio devices 500. The electronic device 400 may be connected to one audio device that operates as a master. In this case, if the electronic device 400 and the first audio device 510 of a master are connected, the electronic device 400 may obtain the first data and the second data from the first audio device 510. For example, the first audio device 510 may receive the second data from the second audio device 520, and may provide the electronic device 400 with the first data of the first audio device 510 and the second data of the second audio device 520, which is received from the second audio device 520. The electronic device 400 may be connected with the first audio device 510 and the second audio device 520, respectively. In this case, the controller 880 may obtain the first data from the first audio device 510 connected with the electronic device 400, and may obtain the second data from the second audio device 520 connected with the electronic device 400.

In step 1005, the controller 880 may determine the state of the audio devices 500 (e.g., the first audio device 510 or the second audio device 520) based on the first data and the second data, which are obtained. For example, the controller 880 may determine the first charging level of the first audio device 510 (e.g., the remaining amount of the battery of the first audio device 510) based on the first data, and may determine the second charging level of the second audio device 520 (e.g., the remaining amount of the battery of the second audio device 520) based on the second data. The controller 880 may compare the first charging level with the second charging level, and may determine which charging level is greater among the first charging level or the second charging level based on the comparison result.

In step 1007, the controller 880 may determine a priority for performing the function using the audio devices 500. For example, the controller 880 may give priority to the audio device (e.g., the first audio device 510 or the second audio device 520) in a good battery state (e.g., a high charging level) based on the battery state of the audio devices 500 according to the first charging level and the second charging level. In the case where the first charging level is greater than the second charging level, the controller 880 may give priority to the audio device 510 having the first charging level.

In step 1009, the controller 880 may detect execution of a function. In an embodiment of the present disclosure, the controller 880 may detect the execution of the function that is related to the outputs of various audio signals through the audio devices 500. The controller 880 may detect the execution of a first function or a second function (e.g., a stereo audio output function, a call function, an alarm function, a speech recognition function, a connection function, or the like) that is performed by the interaction between the electronic device 400 and the audio devices 500. The function (such as a stereo audio output function) that uses both the first audio device 510 and the second audio device 520 may be defined to be the first function. The function (such as a call function, an alarm function, or a speech recognition function) that uses either the first audio device 510 or the second audio device 520 may be defined to be the second function.

In step 1011, the controller 880 may determine whether the detected function corresponds to the first function or the second function.

If the detected function is determined to be the first function in step 1011, the controller 880 may simultaneously control the first audio device 510 and the second audio device 520 in step 1013. According to an embodiment of the present disclosure, the controller 880 may reproduce an audio file based on a user input, and may transmit a stream of audio (e.g., a first audio stream for the first audio device 510 and a second audio stream for the second audio device 520) of the reproduced audio file to the audio devices 500. The controller 880 may transmit, to the audio devices 500, control information (e.g., the first control information) that contains the audio stream related to the first function or that separately contains information related to the execution of the first function (e.g., audio streaming).

In an embodiment of the present disclosure, if the electronic device 400 is connected to one (e.g., the first audio device 510) of the audio devices 500, the controller 880 may transmit the first audio stream and the second audio stream to the connected audio device (e.g., the first audio device 510).

In an embodiment of the present disclosure, if the electronic device 400 is connected to the respective audio devices 500 (e.g., the first audio device 510 and the second audio device 520), the controller 880 may transmit the first audio stream to the first connected audio device 510, and may transmit the second audio stream to the second connected audio device 520.

If the detected function is determined to be the second function in step 1011, the controller 880 may control the audio device (e.g., the first audio device 510 or the second audio device 520) that is given priority among the audio devices 500 in step 1015.

According to an embodiment of the present disclosure, if the controller 880 detects an internal event that is related to the audio output (e.g., an alarm event) or an external event (e.g., a call reception event), the controller 880 may transmit the audio signal of the event to the audio device that was given priority. The controller 880 may transmit, to the audio devices 500, control information (e.g., the second control information) that contains the audio signal related to the second function or that separately contains information related to the execution of the second function (e.g., the audio signal).

According to an embodiment of the present disclosure, provided that the electronic device 400 is connected with the first audio device 510 and priority is given to the first audio device 510, the controller 880 may transmit the audio signal according to the second function to the first audio device 510. Provided that the electronic device 400 is connected to the first audio device 510 and priority is given to the second audio device 520, the controller 880 may transmit, through the first audio device 510, the audio signal to the second audio device 520, which is connected to the first audio device 510. For example, the controller 880 may control the first audio device 510 to transmit the audio signal according to the second function to the second audio device 520, which is connected with the first audio device 510. The controller 880 may transmit, to the first audio device 510, the audio signal and information (or a control signal) requesting for transferring the audio signal to the second audio device 520.

According to an embodiment of the present disclosure, provided that the electronic device 400 is connected to the respective audio devices 500 (e.g., the first audio device 510 and the second audio device 520) and priority is given to the second audio device 520, the controller 880 may transmit the audio signal according to the second function to the second audio device 520.

As described above, an operating method of the electronic device 400 may include establishing connections with the first audio device and the second audio device by using a wireless communication circuit; receiving, from the first audio device, the first data that is related to the charging level of the first battery included in the first audio device; receiving, from the first audio device or the second audio device, the second data that is related to the charging level of the second battery included in the second audio device; and transmitting, to at least one of the first audio device or the second audio device, one or more control signals that enable the first audio device and the second audio device to operate differently from each other based on at least some of the first data and the second data.

According to an embodiment of the present disclosure, the method may further include detecting a change in the corresponding charging level between the first audio device and the second audio device; establishing a reconnection to the audio device having a high corresponding level according to the change in the corresponding charging level between the first audio device and the second audio device; and transmitting the one or more control signals to the reconnected audio device.

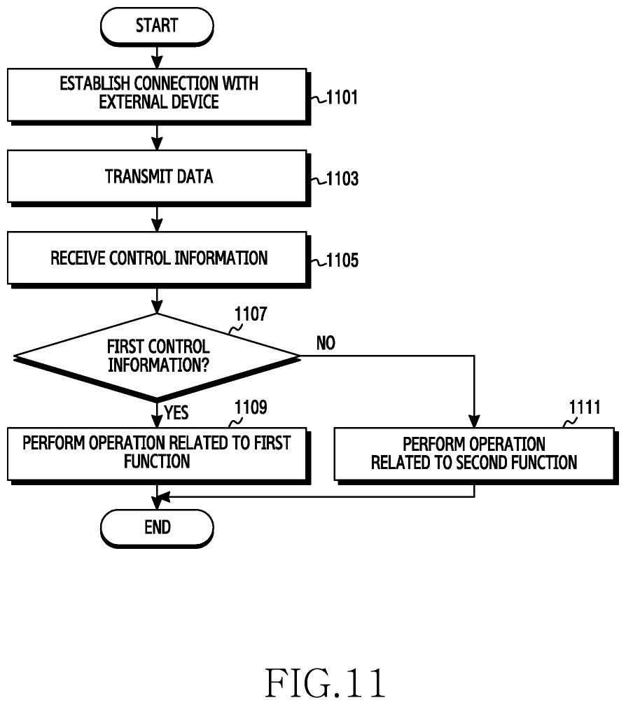

FIG. 11 is a flowchart of a method of an audio device, according to an embodiment of the present disclosure. FIG. 11 may show a method in the case in which an audio device in the audio devices 500 is a master device and is passively operated.

Referring to FIG. 11, in step 1101, the controller 970 of the audio devices 500 may establish a connection to an external device. For example, provided that the audio device in the audio devices 500 is the first audio device 510 in FIG. 11, the first audio device 510 may establish a connection to the electronic device 400 through the first wireless communication. In an embodiment of the present disclosure, the first audio device 510 may selectively establish a connection to the second audio device 520 through the second wireless communication according to a connection method.

In step 1103, the controller 970 may transmit data to the connected electronic device 400. According to an embodiment of the present disclosure, the controller 970 may create the first data that is related to the charging level of the battery of the first audio device 510 (e.g., the remaining amount of battery included in the first audio device 510), and may transmit the first data to the electronic device 400. Provided that the first audio device 510 and the second audio device 520 are connected to each other, the first audio device 510 operates as a master device of the second audio device 520, the controller 970 may obtain, from the second audio device 520, the second data that is related to the charging level of the battery of the second audio device 520 (e.g., the remaining amount of battery included in the second audio device 520), and may transmit the first data and the second data to the electronic device 400.

The controller 970 may receive control information from the connected electronic device 400 in step 1105, and may determine whether the received control information corresponds to the first control information or the second control information in step 1107. In an embodiment of the present disclosure, the first control information may contain information that enables the audio devices 500 (e.g., the first audio device 510, or the first audio device 510 and the second audio device 520) to perform the first selected operation (e.g., the first function), which is received from the electronic device 400. The second control information may contain information that enables the audio devices 500 (e.g., the first audio device 510) to perform the second selected operation (e.g., the second function) or that enables the other audio device (e.g., the second audio device 520 connected to the first audio device 510) to not perform the second selected operation (e.g., the second function), which is received from the electronic device 400. The control information may contain the audio streams or audio signals transmitted from the electronic device 400. The audio devices 500 may receive, from the electronic device 400, the audio streams or the audio signals separately from the control information.

If the received control information is determined to be the first control information in step 1107, the controller 970 may process the execution of the corresponding operation based on the first control information in step 1109. According to an embodiment of the present disclosure, the controller 970 may process the audio stream, which is related to the first function and is received from the electronic device 400, to be output through the speaker. The controller 970 may receive, from the electronic device 400, the first audio stream related to the first function for the first audio device 510 and the second audio stream for the second audio device 520. The controller 970 may process the first audio stream to be output through the speaker, and may process the second audio stream to be transmitted to the second audio device 520 connected and to then be output through the speaker of the second audio device 520.

If the received control information is determined to be the second control information in step 1107, the controller 970 may process the execution of the corresponding operation based on the second control information in step 1111. According to an embodiment of the present disclosure, the controller 970 may process an audio signal, which is related to the second function and is received from the electronic device 400, to be output through the speaker. The controller 970 may transmit, to the second audio device 520, a control signal that disables the second audio device 520 connected with the first audio device 510 to not perform the second function from the electronic device 400.

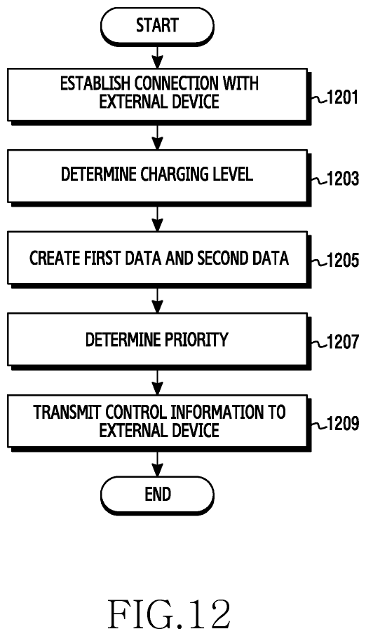

FIG. 12 is a flowchart of a method of an audio device, according to an embodiment of the present disclosure. FIG. 12 may show a method in the case in which an audio device in the audio devices 500 is a master device and actively operates.

Referring to FIG. 12, in step 1201, the controller 970 of the audio devices 500 may establish a connection to an external device. For example, provided that the audio devices 500 includes the first audio device 510 in FIG. 12, the first audio device 510 may establish a connection to the electronic device 400 through the first wireless communication. In an embodiment of the present disclosure, the first audio device 510 may establish a connection to the second audio device 520 through the second wireless communication.

In operation 1203, the controller 970 may determine the battery charging level of the audio devices 500. According to an embodiment of the present disclosure, the controller 970 may detect the battery charging level of the first audio device 510 (e.g., the remaining amount of the first battery included in the first audio device 510, hereinafter referred to as the first charging level), and may detect the battery charging level of the second audio device 520 (e.g., the remaining amount of the second battery included in the second audio device 520, hereinafter referred to as the second charging level) by receiving the same from the second audio device 520 connected with the first audio device 510.

In step 1205, the controller 970 may create data based on the first charging level and the second charging level. According to an embodiment of the present disclosure, the controller 970 may create the first data that is related to the first charging level of the battery of the first audio device 510, and may create the second data that is related to the second charging level of the battery of the second audio device 520. The second data may be created based on the second charging level, which is received by the first audio device 510 from the second audio device 520. The second audio device 520 may detect the second charging level in order to thereby create the second data, and the second audio device 520 may provide the second data instead of the second charging level to the first audio device 510.

In step 1207, the controller 970 may determine the priority for performing the function by interacting with the electronic device 400. For example, the controller 970 may give priority to the audio device (e.g., the first audio device 510 or the second audio device 520) in a good battery state (e.g., a high charging level) based on the battery state of the audio devices 500 according to the first charging level (or the first data) and the second charging level (or the second data). In the case where the first charging level is greater than the second charging level, the controller 970 may give priority to the first audio device 510 having the first charging level.

In step 1209, the controller 970 may transmit, to the external device, control information related to the determined priority. According to an embodiment of the present disclosure, the controller 970 may provide the electronic device 400 connected with the first audio device 510 with the first data and the second data or information on the audio device of which the priority has been determined. The controller 970 may provide the second audio device 520 connected with the first audio device 510 with the information on the audio device, of which the priority has been determined, and information that enables the execution or non-execution of the second function according to the priority.

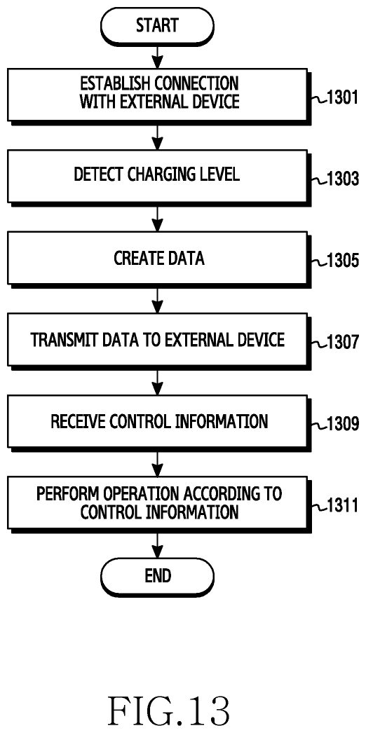

FIG. 13 is a flowchart of a method of an audio device, according to an embodiment of the present disclosure. FIG. 13 may show a method in the case in which an audio device in the audio devices 500 operates as a slave device.

Referring to FIG. 13, in step 1301, the controller 970 of the audio devices 500 may establish a connection to an external device. For example, provided that an audio device in the audio devices 500 is the second audio device 520 in FIG. 13, the second audio device 520 may establish a connection to the electronic device 400 through the first wireless communication. In an embodiment of the present disclosure, the second audio device 520 may establish a connection to the electronic device 400 through the first wireless communication, and may further establish a connection to the first audio device 510 through the second wireless communication. The second audio device 520 may establish a connection to the first audio device 510 by the second wireless communication without the connection to the electronic device 400 by the first wireless communication.

In step 1303, the controller 970 may detect the charging level. For example, the controller 970 may detect the battery charging level of the second audio device 520 (e.g., the remaining amount of battery included in the second audio device 520).

In step 1305, the controller 970 may create data based on the detected charging level. According to an embodiment of the present disclosure, the controller 970 may create data that is related to the battery charging level of the second audio device 520.

In step 1307, the controller 970 may provide the created data to an external device. According to an embodiment of the present disclosure, the controller 970 may provide data to the electronic device 400 or the first audio device 510. If the second audio device 520 is connected to the first audio device 510 of a master device, the controller 970 may provide data to the first audio device 510. If the second audio device 520 is connected to the electronic device 400, the controller 970 may provide data to the electronic device 400.

In step 1309, the controller 970 may receive control information from an external device. According to an embodiment of the present disclosure, the controller 970 may receive control information from the electronic device 400 or the first audio device 510. The control information may contain the audio stream that is related to the first function, or may contain information that is related to the execution of the first function separately from the audio stream. The control information may include information that disables the execution of the second function.

In step 1311, the controller 970 may perform a corresponding operation based on the received control information. In an embodiment of the present disclosure, the controller 970 may process the audio stream to be output through the speaker based on the control information. The controller 970 may enter a standby state (or sleep mode) instead of performing a certain operation based on the control information.

As described above, according to an embodiment of the present disclosure, an operating method of the audio devices 500 may include establishing a connection to an electronic device or to another audio device by using the communication circuit; receiving, from the electronic device, the control information that enables the audio device or the other audio device to perform a selected operation; enabling the audio device to perform the first selected operation based on the control information; and selectively transmitting the control information to the other audio device.

According to an embodiment of the present disclosure, the control information may contain the first control information that enables the audio device, or the audio device and another audio device, to perform a first selected operation, and the second control information that enables the audio device to perform a second selected operation or disables the other audio device to not perform the second selected operation, where the method may further include enabling the audio device to perform the first selected operation based on the first control information; and transmitting, to the second audio device, the first control information or the second control information by using a communication circuit.

According to an embodiment of the present disclosure, the method may further include detecting the charging level of the first battery included in the audio device in order to thereby create the first data; receiving, from the other audio device, the second data that is related to the charging level of the second battery included in the other audio device; and transmitting, to the other audio device, one or more control signals for controlling the other audio device based on at least some of the first data and the second data.

According to an embodiment of the present disclosure, the method may further include establishing connections with the electronic device and the other audio device by using the communication circuit; detecting the charging level of the second battery included in the other audio device in order to thereby create the second data; transmitting the created second data to at least one of the electronic device or the other audio device; receiving, from the electronic device or the other audio device, one or more control signals that enable the other audio device to perform a selected operation; and enabling the other audio device to perform the selected operation based on the one or more control signals.

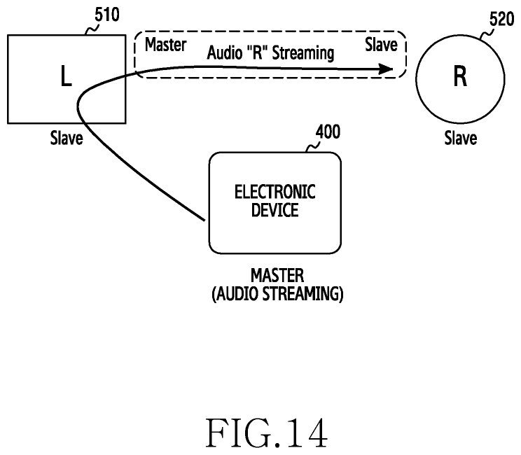

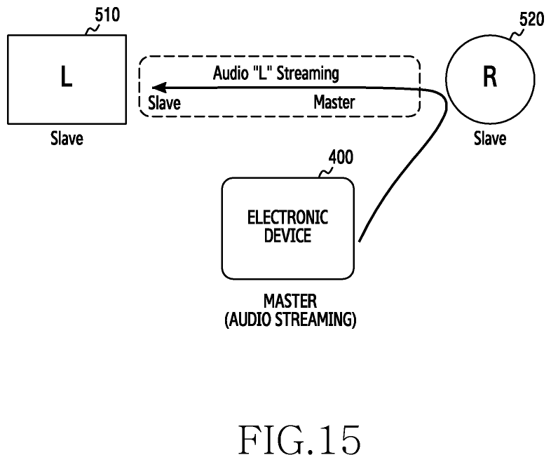

FIGS. 14 and 15 are diagrams of changing a host device in a system, according to an embodiment of the present disclosure.

Referring to FIGS. 14 and 15, FIGS. 14 and 15 show an example of changing a host device of the audio devices 500 (e.g., changing the role of a master or slave) depending on the charging level of the audio devices 500 in the multi-pairing state between the electronic device 400 and the audio devices 500 (e.g., the first audio device 510 or the second audio device 520). According to an embodiment of the present disclosure, the change of the host device may be performed by the electronic device 400 or by the audio device in the audio devices 500 that operates as a master while being connected to the electronic device 400.

As shown in FIG. 14, the electronic device 400 may be connected to the first audio device 510, which operates as a master among the audio devices 500, and the first audio device 510 may be connected (paired) to the second audio device 520. According to an embodiment of the present disclosure, the electronic device 400 may register and manage the first audio device 510 (e.g., the left earpiece (EP_L)) and the second audio device 520 (e.g., the right earpiece (EP_R)) as the audio devices 500, and may connect to one audio device that operates as a master among the first audio device 510 or the second audio device 520. The first audio device 510 and the second audio device 520 may register and manage the counterpart device, respectively, and may configure the master or slave role between the first audio device 510 and the second audio device 520 through the signal communication therebetween. FIG. 14 may show an example in which the first audio device 510 operates as a master device with respect to the second audio device 520.

According to an embodiment of the present disclosure, the electronic device 400 and the first audio device 510 may be connected with each other through the first wireless communication, and the first audio device 510 and the second audio device 520 may be connected to each other through the second wireless communication. The first wireless communication and the second wireless communication may be implemented by the same communication scheme, or by different communication schemes.

According to an embodiment of the present disclosure, the electronic device 400 may operate as a mater device for the audio stream between the electronic device 400 and the first audio device 510, and may transmit the audio stream reproduced by the electronic device 400 to the first audio device 510.

According to an embodiment of the present disclosure, the first audio device 510 may operate as a slave device for the electronic device 400, and may operate as a master device for the second audio device 520. The first audio device 510 may receive the audio stream (e.g., the first audio stream for the first audio device 510 or the second audio stream for the second audio device 520) through the first wireless communication from the electronic device 400. The first audio device 510 may output the received audio stream (e.g., the first audio stream for the first audio device 510) through the speaker. In addition to the output of the audio stream, the first audio device 510 may transmit the audio stream (e.g., the second audio stream for the second audio device 520) to the second audio device 520 through the second wireless communication.

According to an embodiment of the present disclosure, the second audio device 520 may operate as a slave device for the first audio device 510. The second audio device 520 may receive the audio stream (e.g., the second audio streaming for the second audio device 520) through the second wireless communication from the first audio device 510. The second audio device 520 may output the received audio stream (e.g., the second audio stream for the second audio device 520) through the speaker.

According to an embodiment of the present disclosure, in the operating state as shown in FIG. 14, the electronic device 400 may obtain the battery charging level of the first audio device 510 (hereinafter, the first charging level) and the battery charging level of the second audio device 520 (hereinafter, the second charging level) through a periodic negotiation with the first connected audio device 510. The electronic device 400 may compare the first charging level with the second charging level in order to thereby determine a master device between the first audio device 510 and the second audio device 520.

According to an embodiment of the present disclosure, if the first charging level is greater than the second charging level, the electronic device 400 may determine the first audio device 510 having the first charging level to be a master device, and may maintain the connection to the first audio device 510.

According to an embodiment of the present disclosure, if the second charging level is greater than the first charging level, the electronic device 400 may determine the second audio device 520 of the second charging level to be a master device, and may determine to change the connection of the audio devices 500. The electronic device 400 may process the operation that is related to the execution of a connection to the second audio device 520. For example, the electronic device 400 may process a signal communication operation for a connection (e.g., pairing) with the second audio device 520 based on the first wireless communication. The electronic device 400 may provide a control signal that enables the second audio device 520 to operate as a master in the signal communication operation. If the electronic device 400 switches the connection from the first audio device 510 to the second audio device 520, the electronic device 400 may perform an operation of releasing the connection to the first audio device 510. The electronic device 400 may instruct to configure a connection to the second audio device 520 through the first audio device 510, and may process an intermediate operation in order for the first audio device 510 to configure a connection between the electronic device 400 and the second audio device 520 (for example, an operation of transferring a control signal of the electronic device 400).

According to an embodiment of the present disclosure, in the operating state as shown in FIG. 14, the first audio device 510, which operates as a master device, may periodically detect the battery charging level of the first audio device 510 (hereafter, the first charging level), and may obtain the battery charging level of the second audio device 520 (hereinafter, the second charging level) through a periodic negotiation with the first audio device 510, which is connected thereto. The first audio device 510 may compare the first charging level with the second charging level in order to thereby determine a master device between the first audio device 510 and the second audio device 520.

According to an embodiment of the present disclosure, if the first charging level is greater than the second charging level, the first audio device 510 may be determined to be a master device so that the current role thereof may be maintained. The first audio device 510 may provide the electronic device 400 with information on the determination of the master device.

According to an embodiment of the present disclosure, if the second charging level is greater than the first charging level, the first audio device 510 may determine the second audio device 520 to be a master device, and may determine the role change (for example, a master to a slave). The first audio device 510 may process the operations that are related to the role change from the master device to the slave device. For example, the first audio device 510 may process the signal communication operation to enable the second audio device 520 to operate as a master device based on the second wireless communication. The first audio device 510 may provide information to enable the second audio device 520 to configure a connection to the first audio device 510 based on the first wireless communication in the signal communication operation with the second audio device 520. The first audio device 510 may control the second audio device 520 to operate as a master and may perform an operation of releasing the connection to the electronic device 400 if changing the role thereof. The first audio device 510 may provide information to enable the electronic device 400 to configure a connection to the second audio device 520 through the first wireless communication.

The connection state of the electronic device 400 and the audio devices 500, according to the aforementioned operation, is illustrated in FIG. 15.

As shown in FIG. 15, the electronic device 400 may disconnect from the first audio device 510, and may connect to the second audio device 520, which is configured to be a master device, through the first wireless communication. The first audio device 510 and the second audio device 520 may be connected to each other through the second wireless communication. FIG. 15 may show the state in which the roles of a master and a slave of the first audio device 510 and the second audio device 520 have been changed. In this case, the second audio device 520 may receive the audio stream (e.g., the first audio stream or the second audio stream) from the electronic device 400 through the first wireless communication. The second audio device 520 may output the received audio stream (e.g., the second audio stream) through the speaker, and, in addition to the output of the second audio stream, may transmit the audio stream (e.g., the first audio stream) to the first audio device 510 through the second wireless communication.

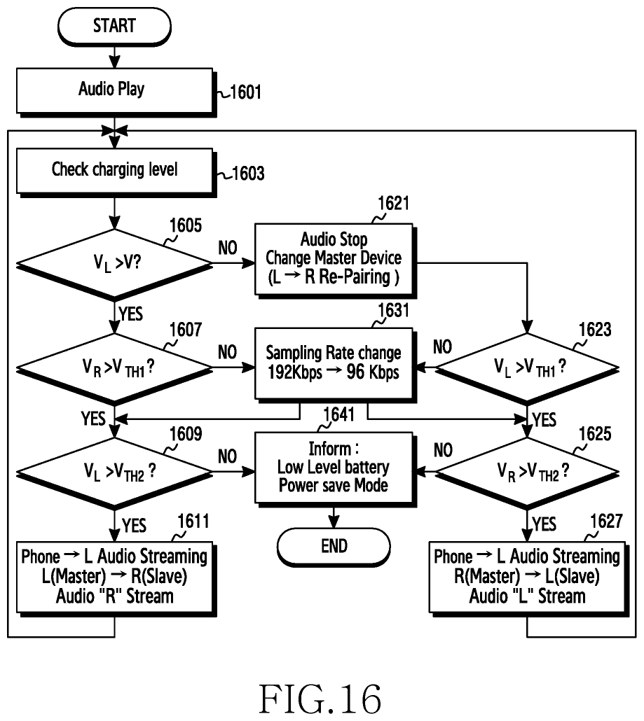

FIG. 16 is a flowchart of a method of changing a host device in an electronic device, according to an embodiment of the present disclosure.

Referring to FIG. 16, in step 1601, the electronic device 400 may perform an operation related to the reproduction of audio data. For example, the electronic device 400 may reproduce selected audio data based on a user input, and may transmit an audio stream according to the audio reproduction to the first audio device 510 to which the electronic device 400 is connected. FIG. 16 may show an example in which the electronic device 400 and the first audio device 510 is connected to each other and the first audio device 510 operates as a master device for the second audio device 520 as described in FIG. 15.

In step 1603, the controller 880 may check the charging level of the audio devices 500. According to an embodiment of the present disclosure, the controller 880 may detect the battery charging level of the first audio device 510 (hereinafter, the first charging level, VL) and the battery charging level of the second audio device 520 (hereinafter, the second charging level, VR). The first charging level (VL) and the second charging level (VR) may be obtained based on at least one audio device that is connected to the electronic device 400. In the case where the electronic device 400 and the first audio device 510 are connected, the first charging level (VL) and the second charging level (VR) may be obtained through the first audio device 510. In the case where the electronic device 400 is connected to the first audio device 510 and the second audio device 520, respectively, the first charging level (VL) may be obtained through the first audio device 510 and the second charging level (VR) may be obtained through the second audio device 520.

In step 1605, the controller 880 may compare the first charging level (VL) and the second charging level (VR) for determination. For example, the controller 880 may compare the remaining amount of battery power of the first audio device 510 with the remaining amount of battery power of the second audio device 520 in order to thereby determine which is greater.

If the first charging level (VL) is determined to be less (e.g., less than or equal to) than the second charging level (VR) (e.g., VL_{<}VR) in step 1605, the controller 880 may control an operation that is related to the change of the master device in 1621. According to an embodiment of the present disclosure, the controller 880 may stop transmitting the audio stream to the first audio device 510, and may perform an operation for reconnecting to (e.g., being re-paired with) the second audio device 520 in the first audio device 510. The operation of stopping the audio stream transmission may include an operation of disconnecting the electronic device 400 from the first audio device 510. The controller 880 may perform the connection operation with the second audio device 520 according to step 1621, and thereafter, may proceed to step 1623 in order to thereby perform the subsequent operations.

If the first charging level (VL) is determined to be greater than the second charging level (VR) (e.g., VL>VR) in step 1605, the controller 880 may determine the state of the second charging level (VR) in step 1607. For example, the controller 880 may compare the second charging level (VR) (e.g., the remaining amount of battery power of the second audio device 520) with the first threshold level (e.g., VTH1) (e.g., 3.6V), which is configured, in order to thereby determine whether the second charging level (YR) is greater than or less than the first threshold level (VTH1).

If the second charging level (VR) is determined to be less than the first threshold level (VTH1) (e.g., VR<VTH1) in step 1607, the controller 880 may adjust (change) the sampling rate of the audio stream for the second audio device 520 in step 1631. For example, provided that the basic sampling rate (e.g., the sampling rate for a high sound quality or a standard sound quality) is configured to the audio stream for the audio devices 500, if the corresponding charging level is less than the threshold level, the basic sampling rate may be lowered. The controller 880 may change (e.g., lower) the basic sampling rate (e.g., 192 Kbps) to a sampling rate of a certain size (e.g., 96 Kbps). The controller 880 may adjust the sampling rate of the audio stream for the second audio device 520, and thereafter, may proceed to step 1609 in order to thereby perform the subsequent operations.

If the second charging level (VR) is determined to be greater than the first threshold level (VTH1) (e.g., VR>VTH1) in step 1607, the controller 880 may determine the state of the first charging level (VL) in step 1609. For example, the controller 880 may compare the first charging level (VL) (e.g., the remaining amount of battery power of the first audio device 510) to the second threshold level (e.g., VTH2) (e.g., 3.5V), which is configured, in order to thereby determine whether the first charging level (VL) is greater than or less than the second threshold level (VTH2).

If the first charging level (VL) is determined to be greater than the second threshold level (VTH2) (e.g., VL>VTH2) in step 1609, the controller 880 may transmit the audio stream to the first audio device 510 in step 1611. For example, the controller 880 may transmit, to the first audio device 510, the first audio stream for the first audio device 510 and the second audio stream for the second audio device 520. If the audio stream is received from the electronic device 400, the first audio device 510 may output the first audio stream through the speaker, and may provide the second audio stream to the second audio device 520. The controller 880 may adjust the sampling rate of the second audio stream to then transmit the same according to the result of step 1631 if transmitting the audio stream. For example, the controller 880 may transmit the first audio stream at 192 Kbps, and may transmit the second audio stream at 96 Kbps.

If the first charging level (VL) is determined to be less than the second threshold level (VTH2) (e.g., VL<VTH2) in step 1609, the controller 880 may notify of the low level battery state of the audio devices 500 in step 1641. According to an embodiment of the present disclosure, if the low level state of the audio devices 500 is determined, the controller 880 may process the audio devices 500 to operate in the power saving mode. The controller 880 may make a control to adjust the sampling rate of the audio stream of the audio devices 500 to a configured minimum value.

After step 1621, the controller 880 may determine the state of the first charging level (VL) in step 1623. For example, the controller 880 may compare the first charging level (VL) (e.g., the remaining amount of battery power of the first audio device 510) to the first threshold level (e.g., VTH1) (e.g., 3.6V), which is configured, in order to thereby determine whether the first charging level (VL) is greater than or less than the first threshold level (VTH1).

If the first charging level (VL) is determined to be less than the first threshold level (VTH1) (e.g., VL<VTH1) in step 1623, the controller 880 may proceed to step 1631 in order to thereby perform the subsequent operations. For example, the controller 880 may adjust (change) the sampling rate of the audio stream for the first audio device 510, which has been configured (changed) to be a slave, in step 1631. For example, provided that the basic sampling rate (e.g., the sample rate for a high sound quality or a standard sound quality) is configured to the audio stream for the audio devices 500, if the charging level of the corresponding audio device is less than the threshold level, the basic sampling rate may be lowered. According to an embodiment of the present disclosure, the controller 880 may change (e.g., lower) the basic sampling rate (e.g., 192 Kbps) to a sampling rate of a certain size (e.g., 96 Kbps). The controller 880 may adjust the sampling rate of the audio stream for the first audio device 510, and thereafter, may proceed to step 1625 in order to thereby perform the subsequent operations.

If the first charging level (VL) is determined to be greater than the first threshold level (VTH1) (e.g., VL>VTH1) in step 1623, the controller 880 may determine the state of the second charging level (VR) in step 1625. For example, the controller 880 may compare the second charging level (VR) (e.g., the remaining amount of battery power of the second audio device 520) with the second threshold level (e.g., VTH2) (e.g., 3.5V), which is configured, in order to thereby determine whether the second charging level (VR) is greater than or less than the second threshold level (VTH2).

If the second charging level (VR) is determined to be less than the second threshold level (VTH2) (e.g., VR<VTH2) in step 1625, the controller 880 may proceed to step 1641 in order to thereby perform the subsequent operations.

If the second charging level (VR) is determined to be greater than the second threshold level (VTH2) (e.g., VR>VTH2) in step 1625, the controller 880 may transmit the audio stream to the second audio device 520, which has been configured (changed) to be a master (or which has been reconnected), in step 1627. For example, the controller 880 may transmit, to the second audio device 520, the first audio stream for the first audio device 510 and the second audio stream for the second audio device 520. If the audio stream is received from the electronic device 400, the second audio device 520 may output the second audio stream through the speaker, and may provide the first audio stream to the first audio device 510. The controller 880 may adjust the sampling rate of the first audio stream to then transmit the same according to the result of step 1631 if transmitting the audio stream. For example, the controller 880 may transmit the second audio stream at 192 Kbps, and may transmit the first audio stream at 92 Kbps.

FIG. 16 illustrates an example in which a host device is changed according to the battery charging level of the audio devices 500 in the electronic device 400. However, the present disclosure is not limited thereto, and the change of the host device according to FIG. 16 may be performed by the audio device that is connected with the electronic device 400 and operates as a master with respect to the other audio device.

As described above, according to an embodiment of the present disclosure, the electronic device 400 or the audio devices 500, for example, may determine whether or not the audio devices 500 are worn on the user's body (e.g., the ears) based on an HRM sensor of the audio devices 500. The electronic device 400 or the audio devices 500 may determine the execution of functions by the audio device based on the charging level and the wearing state. It may be assumed that the first charging level of the first audio device 510 is greater than the second charging level of the second audio device 520, and it may be assumed that the first audio device 510 is not worn (e.g., the second audio device 520 is worn) by a user. In this case, even though the charging level of the first audio device 510 is greater than the charging level of the second audio device 520 if the second audio device 520 is worn by a user, the electronic device 400 or the audio devices 500 may process an event of the electronic device 400, which corresponds to the second function, to be performed by the second audio device 520. For example, the electronic device 400 may transmit the event in accordance with the second function to the second audio device 520, which is currently worn.

According to an embodiment of the present disclosure, the audio devices 500 may include a battery, and the battery of the audio devices 500 may be charged through a separate charging device 600 (e.g., a battery charging dock or a cradle). The battery of the audio devices 500 may be charged by directly receiving the output power of a power supply device (e.g., a travel adapter (TA) or a power supply). An example of charging the battery of the audio devices 500 by the interaction of the audio devices 500 and the charging device 600, or the electronic device 400, the audio devices 500, and the charging device 600 is provided below.

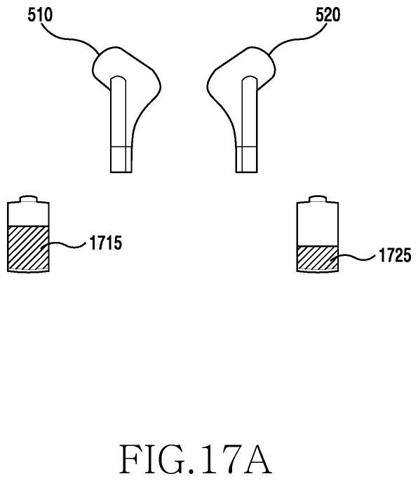

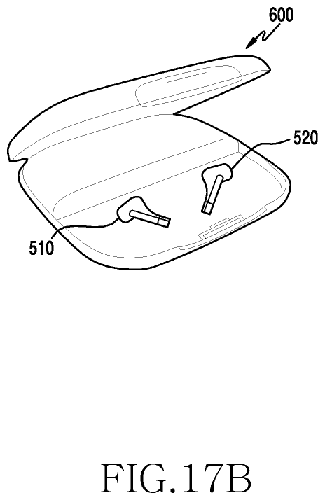

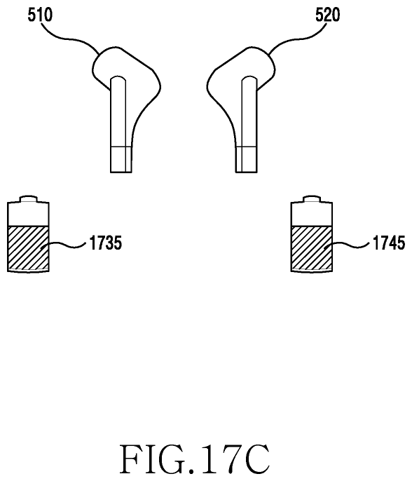

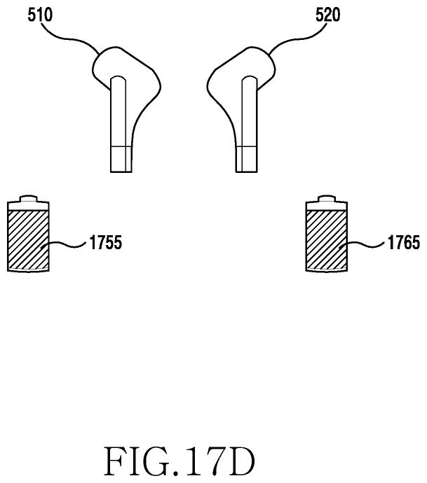

FIGS. 17A to 17D are diagrams of charging the audio device, according to an embodiment of the present disclosure.

Referring to FIG. 17A, FIG. 17A may show an example in which the remaining amount of battery power of the first audio device 510 (hereinafter, the first charging level) 1715 is greater than the remaining amount of battery power of the second audio device 520 (hereinafter, the second charging level) 1725.

Referring to FIG. 17B, FIG. 17b may show an example in which the first audio device 510 and the second audio device 520 are charged through the charging device 600.

According to an embodiment of the present disclosure, the charging device 600 may include an internal battery, and may provide a charging function to the audio devices 500 even without a separate power supply device. The charging device 600 may be connected to the power supply device, and may provide a charging function to the audio devices 500 regardless of the internal battery.

According to an embodiment of the present disclosure, the audio devices 500 may detect a connection to the charging device 600 (e.g., the state in which the audio devices 500 are mounted (placed) on the charging device 600 and recognizes the charging device 600 through a wired or wireless interface). if the audio devices 500 detect a connection to the charging device 600, the audio devices 500 may detect the charging level in order to thereby transmit, to the charging device 600, battery state information (e.g., battery percentage information) according thereto. The state information of the audio devices 500 may be provided based on the audio device that operates as a master device. The state information of the audio devices 500 may be provided by the first audio device 510 and the second audio device 520, respectively. The electronic device 400 may detect a connection between the audio devices 500 and the charging device 600, and the electronic device 400 may provide the state information of the audio devices 500 to the charging device 600 in response thereto.

The charging device 600 may process the charging operation for the audio devices 500 based on the state information of the audio devices 500. According to an embodiment of the present disclosure, the charging device 600 may compare the first battery state information of the first audio device 510 (hereinafter, the first charging level 1715) and the second battery state information of the second audio device 520 (hereinafter, the second charging level 1725). The charging device 600 may supply charging power to at least one of the first audio device 510 or the second audio device 520. The charging device 600 may preferentially supply charging power to the audio device having a low charging level or at a high ratio based on the charging level if supplying charging power to the first audio device 510 and the second audio device 520. For example, if the second charging level 1725 is determined to be lower than the first charging level 1715 as a result of comparing the first charging level 1715 with the second charging level 1725, the charging device 600 may preferentially supply charging power to the second audio device 520, or may supply charging power to the second audio device 520 at a higher ratio than the charging power supplied to the first audio device 510.

When the charging device 600 performs the charging of the audio devices 500 by differentially supplying charging power to the first audio device 510 and the second audio device 520, the charging device 600 may monitor the charging levels of the first audio device 510 and the second audio device 520. In the monitoring of the charging levels, it is possible to compare the first charging level with the second charging level for a determination based on the periodic charging level detection of the charging device 600 or based on the information provided by the electronic device 400 as described above.

As shown in FIG. 17C, the charging device 600 may detect that the first charging level 1735 of the first audio device 510 and the second charging level 1745 of the second audio device 520 are the same or similar (hereinafter, the same level). If the first charging level 1735 and the second charging level 1745 have the same level, the charging device 600 may supply charging power at an equal or the same ratio to the first audio device 510 and the second audio device 520. The charging device 600 may fully charge the first battery and the second battery of the first audio device 510 and the second audio device 520 based on the operation described above. For example, as shown in FIG. 17D, the first charging level 1755 of the first audio device 510 and the second charging level 1765 of the second audio device 520 may be fully charged at the same or a similar time.

According to various embodiments, the charging device 600 may perform the charging of the audio devices 500 by internally detecting the charging level, or may perform the charging based on the charging level for the audio devices 500 or control information (e.g., the charging ratio for the audio devices 500) for charging, which is provided by the electronic device 400, by interacting with the electronic device 400.

According to an embodiment of the present disclosure, in the case where the charging device 600 charges the audio devices 500 by an internal battery without a connection to a power supply device (e.g., an external power supply), the charging device 600 may operate to preferentially charge only the battery of the audio device having an insufficient voltage (e.g., a low charging level) according to the remaining amount of battery power (e.g., the charging level) of the audio devices 500. Such an operation of the charging device 600 may be performed if the remaining amount of battery power of the charging device 600 is less than or equal to a predetermined threshold level.

According to an embodiment of the present disclosure, if the external current supply is not sufficient, the charging device 600 may perform the charging based on at least one of a charging priority allocation; a rate change; or the control of a constant current (CC) charging period. If the current supply of the internal battery is not sufficient, the charging device 600 may perform the charge through the allocation of the battery charging priority.

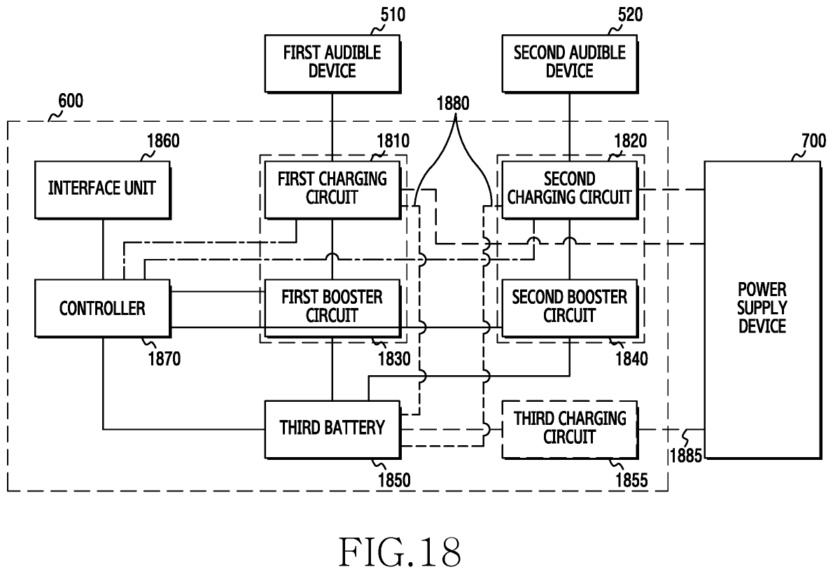

FIG. 18 is a block diagram of a charging device 600, according to an embodiment of the present disclosure.

Referring to FIG. 18, the charging device 600, according to an embodiment of the present disclosure, may be configured to include a first charging circuit 1810 (e.g., a charger IC), a second charging circuit 1820, a first booster circuit 1830 (e.g., a booster), a second booster circuit 1840, a third battery 1850 (e.g., an internal battery of the charging device 600), an interface unit 1860, and a controller 1870 (e.g., a processor or n micro controller units (MCUs)). The charging device 600 may be connected to the audio devices 500 (e.g., the first audio device 510 and the second audio device 520), and may be connected to a power supply device 700 for supplying external power. In an embodiment of the present disclosure, all of the elements shown in FIG. 18 may not be essential, so the charging device 600 and peripheral devices connected thereto may be implemented to have more, or fewer, elements than the elements shown in FIG. 18. For example, the charging device 600 may be implemented by further including a third charging circuit 1855 for supplying charging power to the third battery 1850. Although the first booster circuit 1830, the first charging circuit 1810, the second booster circuit 1840, and the second charging circuit 1820 are illustrated as separate elements in FIG. 18, for example, the first booster circuit 1830 and the first charging circuit 1810 may be implemented in a single configuration (e.g., a single circuit), and the second booster circuit 1840 and the second charging circuit 1820 may be implemented in a single configuration.

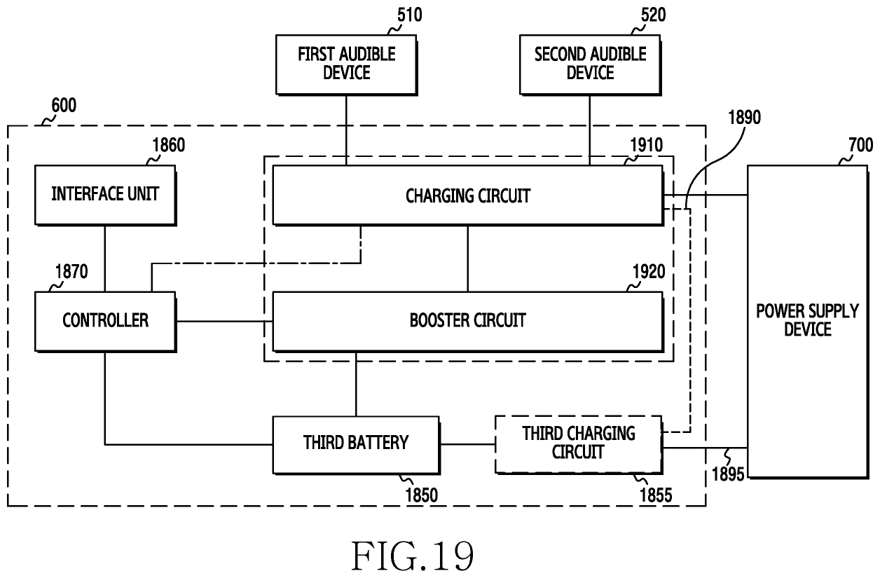

According to an embodiment of the present disclosure, the first charging circuit 1810 and the second charging circuit 1820 may supply electrical energy (e.g., charging power) to the battery of the audio devices 500 (e.g., the first battery of the first audio device 510 or the second battery of the second audio device 520), which is connected to the charging device 600. The first charging circuit 1810 and the second charging circuit 1820 may provide at least one of the first battery or the second battery with a voltage that is applied through one or more booster circuits or the external power supply device 700. The first charging circuit 1810 and the second charging circuit 1820 may supply charging power to at least one of the first battery or the second battery to be charged selectively, or at a different ratio, according to the control of the controller 1870. The first charging circuit 1810 and the second charging circuit 1820 may be implemented at least in two circuits, or may be implemented as a single circuit as shown in FIG. 19.

According to an embodiment of the present disclosure, the first booster circuit 1830 and the second booster circuit 1840 may refer to a circuit that outputs a greater voltage than an input voltage. The first booster circuit 1830 and the second booster circuit 1840 may be connected to the third battery 1850, and may boost the voltage of the connected third battery 1850 to then be provided to at least one of the first charging circuit 1810 or the second charging circuit 1820. The first booster circuit 1830 may be connected to the third battery 1850, and may boost the voltage of the connected third battery 1850 to a certain value according to the control of the controller 1870 to then be provided to the first charging circuit 1810. The second booster circuit 1840 may be connected to the third battery 1850, and may boost the voltage of the connected third battery 1850 to a certain value according to the control of the controller 1870 to then be provided to the second charging circuit 1820. The first booster circuit 1830 and the second booster circuit 1840 may boost the voltage of the third battery 1850 at different levels, or at different ratios, according to the controller 1870, and may provide the same to the first charging circuit 1810 and the second charging circuit 1820 corresponding thereto. The first booster circuit 1830 and the second booster circuit 1840 may be implemented at least in two circuits, or may be implemented as a single circuit as shown in FIG. 19 in order to thereby provide voltage to at least one of the first charging circuit 1810 or the second charge circuit 1820 selectively or at a different ratio.

According to an embodiment of the present disclosure, a third battery 1850 may be implemented in one or more batteries. For example, the third battery 1850 may be separated into a battery for supplying power to the first audio device 510 through the first charging path and a battery for supplying power to the second audio device 520 through the second charging path. The third battery 1850 may be implemented to be mounted inside the charging device 600, or may be external to the charging device 600. The third battery 1850 may be functionally, electrically, or physically connected to the charging device 600 through a variety of interfaces. For example, the third battery 1850 may include a rechargeable battery and/or solar cells.

According to an embodiment of the present disclosure, the third charging circuit 1855 may supply electrical energy (e.g., charging power) to the third battery 1850 of the charging device 600. The third charging circuit 1855 may provide the third battery 1850 with a voltage that is applied through the external power supply device 700. The third charging circuit 1855 may supply charging power to charge the third battery 1850 according to the control of the controller 1870. The third charging circuit 1855 may be omitted from the configuration of FIG. 18, and the third charging circuit 1855, as indicated by the reference numeral 1880, may be implemented to be a charging circuit for the third battery 1850 based on at least one of the first charging circuit 1810 or the second charging circuit 1820 by electrically connecting (1880) at least one of the first charging circuit 1810 or the second charging circuit 1820 to the third battery 1850. In the case where at least one of the first charging circuit 1810 or the second charging circuit 1820 is electrically connected (1880) to the third battery 1850 (for example, if there is no third charging circuit 1855), the third battery 1850 may be supplied with charging power through the connection (1880) of at least one of the first charging circuit 1810 or the second charging circuit 1820 while removing the connection between the third charging circuit 1885 and the power supply device 700 in FIG. 18.

According to an embodiment of the present disclosure, the interface unit 1860 (e.g., the communication circuit), for example, may receive data from at least one of the audio devices 500 or the electronic device 400, and may transfer the same to the controller 1870. The interface unit 1860 may enable the internal data of the charging device 600 to be transmitted to the audio devices 500 or the electronic device 400. The interface unit 1860 may include a wired communication interface that is functionally, electrically, or physically connected to the audio devices 500 to transmit and receive data signals (e.g., an audio devices 500 detection signal, the charging level, or the like) to and from the audio devices 500; a wireless communication interface that is functionally connected to the audio devices 500 to transmit and receive data signals (e.g., an audio devices 500 recognition signal or the charging level) to and from the audio devices 500; and a wireless communication interface that is functionally connected to the electronic device 400 to transmit and receive data signals (or instructions) (e.g., a control signal related to the charging control of the audio devices 500, the charging level of the audio devices 500, or the like) to and from the electronic device 400. The interface unit 1860 may include a wired data interface (e.g., a pogo pin, a USB, or the like) or a wireless data interface (e.g., BLE, NFC, ZigBee, UWB, IrDA, or the like).

According to an embodiment of the present disclosure, the controller 1870 may control the overall operations of the charging device 600. The controller 1870 may determine whether or not the audio devices 500 is connected through the interface unit 1860. The controller 1870 may determine the battery charging level of the audio devices 500, which is connected. For example, the controller 1870 may obtain the first charging level of the first battery of the first audio device 510 and the second charging level of the second battery of the second audio device 520 from the audio devices 500 or the electronic device 400 for determination. The controller 1870 may obtain the charging levels from the first audio device 510 and the second audio device 520 through the interface unit 1860, or may obtain the charging levels of the first audio device 510 and the second audio device 520, which are provided by the electronic device 400 through the interface unit 1860.

According to an embodiment of the present disclosure, the controller 1870 may compare the first charging level with the second charging level in order to thereby determine the priority for initiating the charging operation. The controller 1870 may make a control to supply charging power to the first battery of the first audio device 510 and the second battery of the second audio device 520 selectively, or at a different ratio, according to the determined priority. The controller 1870 may make a control to adjust the voltage of at least one of the first booster circuit 1830 or the second booster circuit 1840 in order to thereby supply the same voltage, or different voltages, to the first audio device 510 and the second audio device 520. The controller 1870 may continuously check the first charging level of the first audio device 510 and the second charging level of the second audio device 520, which are currently charged, and if the first charging level and the second charging level become equal, the controller 1870 may make a control to adjust the voltage of at least one of the first booster circuit 1830 or the second booster circuit 1840 in order to thereby stop the charging operation or in order to thereby supply charging power at the same ratio.

According to an embodiment of the present disclosure, the controller 1870 may establish connections with the first audio device 510 and the second audio device 520 by using the interface unit 1860 (e.g., the communication circuit). The controller 1870 may receive, from the first audio device 510, the first data that is related to the first charging level of the first battery of the first audio device 510, and may receive, from the second audio device 520, the second data that is related to the second charging level of the second battery of the second audio device 520. The controller 1870 may control at least one of the booster circuit or the charging circuit to supply the power supplied from the third battery 1850 to the first audio device 510 or the second audio device 520 selectively, or at a different ratio, through the first charging path (e.g., a power interface) (e.g., a path of battery to booster circuit to charging circuit to audio device) based on at least some of the first data and the second data. The controller 1870 may control at least one of the booster circuit or the charging circuit to supply the power supplied from the power supply device 700 to the first audio device 510 or the second audio device 520 selectively, or at a different ratio, through the second charging path (e.g., a power interface) (e.g., a path of power supply device to charging circuit to audio device) based on at least some of the first data and the second data.

According to an embodiment of the present disclosure, the controller 1870 may establish a connection to the electronic device 400 by using the interface unit 1860 (e.g., the communication circuit). The controller 1870 may receive, from the electronic device 400, a control signal that enables the first battery of the first audio device 510 or the second battery of the second audio device 520 to be charged selectively or at a different ratio. The controller 1870 may control at least one of the booster circuit or the charging circuit to supply the power supplied from the third battery 1850 to the first audio device 510 or the second audio device 520 selectively, or at a different ratio, through the first charging path based on the control signal. The controller 1870 may control the charging circuit to supply the power supplied from the power supply device 700 to the first audio device 510 or the second audio device 520 selectively, or at a different ratio, through the second charging path based on the control signal.

According to an embodiment of the present disclosure, the charging device 600 may be implemented to include a battery percentage measuring circuit (e.g., a power gauge). The battery percentage measuring circuit may measure information of the third battery 1850 (e.g., the remaining amount of battery power or the charging level), information on the first battery of the first audio device 510, or information on the second battery of the second audio device 520. For example, the information on the battery may contain the remaining amount of batter power, a charging voltage, current, or temperature of the battery. The battery percentage measuring circuit may measure information of the third battery 1850 based on a signal that is received through the third electrical path connected to the third battery 1850. The battery percentage measuring circuit may measure information of the first battery based on a signal that is received through the first electrical path connected to the first battery of the first audio device 510. The battery percentage measuring circuit may measure information of the second battery based on a signal that is received through the second electrical path connected to the second battery of the second audio device 520. The battery percentage measuring circuit may provide the controller 1870 with the measured information on one or more batteries.

FIG. 19 is a block diagram of a charging device, according to an embodiment of the present disclosure.

Referring to FIG. 19, the charging device 600, according to an embodiment of the present disclosure, may be configured to include a charging circuit 1910, a booster circuit 1920, the third battery 1850, an interface unit 1860, and a controller 1870, and may have the same, or a similar, configuration as the charging device 600 of FIG. 18 described above. The charging device 600 may be connected to the audio devices 500 (e.g., the first audio device 510 and the second audio device 520), and may be connected to the power supply device 700 which supplies external power. In an embodiment of the present disclosure, the elements shown in FIG. 19 may not be essential, so the charging device 600 and peripheral devices connected thereto may be implemented to have more, or fewer, elements than the elements shown in FIG. 19. For example, the charging device 600 may be implemented by further including the third charging circuit 1855 for supplying charging power to the third battery 1850. Although the booster circuit 1920 and the charging circuit 1910 are illustrated to be separate elements in FIG. 19, for example, the booster circuit 1920 and the charging circuit 1910 may be implemented in a single configuration (e.g., a single circuit).

As shown in FIG. 19, FIG. 19 may show an example in which one charging circuit 1910 and one booster circuit 1920 are provided as compare to FIG. 18. In addition, the charging of the audio devices 500 is performed by charging power supplied from the power supply device 700 in FIG. 19, and, in this case, the booster circuit 1920 and the third battery 1930 may not be included in the configuration of the charging device 600.

According to an embodiment of the present disclosure, the configuration and operation of the charging device 600 shown in FIG. 19 may correspond to the configuration and operation of the charging device 600 shown in FIG. 18. For example, the charging circuit 1910 of FIG. 19 may correspond to the first charging circuit 1810 and the second charging circuit 1820 of FIG. 18, and the booster circuit 1920 of FIG. 19 may correspond to the first booster circuit 1830 and the second booster circuit 1840 of FIG. 18. The third battery 1850 of FIG. 19 may correspond to the third battery 1850 of FIG. 18, and the third charging circuit 1855 of FIG. 19 may correspond to the third charging circuit 1855 of FIG. 18. The interface unit 1860 of FIG. 19 may correspond to the interface unit 1860 of FIG. 18, and the controller 1870 of FIG. 19 may correspond to the controller 1870 of FIG. 18. Therefore, in various embodiments, the configuration of the charging device 600 of FIG. 19 may correspond to the configuration of the charging device 600 described above with reference to FIG. 18, so the detailed description thereof is omitted here.

In an embodiment of the present disclosure, the third charging circuit 1855 may be omitted from the configuration of FIG. 19, and the third charging circuit 1855, as indicated by the reference numeral 1890, may be implemented to be a charging circuit for the third battery 1850 based on the charging circuit 1910 by electrically connecting the charging circuit 1910 to the third battery 1850. In the case where the charging circuit 1910 is electrically connected (1890) to the third battery 1850 (for example, if there is no third charging circuit 1855), the third battery 1850 may be supplied with charging power through the connection (1890) of the charging circuit 1910 while removing the connection between the third charging circuit 1885 and the power supply device 700 in FIG. 19.

In FIG. 19, one charging circuit 1910 of the charging device 600 may be connected to two batteries (e.g., the first battery and the second battery) of the first audio device 510 and the second audio device 520. Therefore, the charging circuit 1910 may be configured to include a switch for a selective connection to at least one of the first battery or the second battery.

According to an embodiment of the present disclosure, as described in FIG. 18, two charging circuits (e.g., the first charging circuit 1810 and the second charging circuit 1820) of the charging device 600 may be connected to the first battery of the first audio device 510 and the second battery of the second audio device 520, respectively, to correspond to the first audio device 510 and the second audio device 520. One charging circuit (e.g., the charging circuit 1910) of the charging device 600 may be connected to the first battery of the first audio device 510 and the second battery of the second audio device 520 to correspond to the first audio device 510 and the second audio device 520.

According to an embodiment of the present disclosure, the charging device 600 may operate to give priority to a low voltage battery among the first battery of the first audio device 510 and the second battery of the second audio device 520 in order to thereby charge the corresponding battery first, or may operate to charge the first battery and the second battery with different charging powers (e.g., supply a high charging power to a low voltage battery and supply a low charging power to a high voltage battery).

According to an embodiment of the present disclosure, in the case where the charging device 600, for example, performs charging based on the third battery 1850 without a connection to the power supply device 700, if the supply current (or the amount of current) of the input power source by the third battery 1850 is insufficient (e.g., is lower than the threshold level) to simultaneously charge the first audio device 510 and the second audio device 520, the charging device 600 may operate to charge the battery of a low voltage audio device, or may operate to distribute the current to the battery of a low voltage audio devices 500 at a high ratio to then charge the same.

According to an embodiment of the present disclosure, for example, even if the supply current (or the amount of current) of the input power source is sufficient or if external power is supplied by the power supply device 700, the charging device 600 may make a control to perform the maximum charging (e.g., supply the maximum amount of current) through a pulse change or a voltage change in less than the configured maximum charging current (e.g., the CC period) in order to thereby minimize the average charge time. The current configuration may be designated by the voltage difference between the first battery of the first audio device 510 and the second battery of the second audio device 520.

As described above, the charging device 600, may include a housing; a communication circuit configured to be disposed in the housing; a power interface configured to be disposed in the housing; and a control circuit configured to be electrically connected to the communication circuit and the power interface, wherein the housing includes one or more fixing members that are configured to accommodate the first earpiece including the first battery and the second earpiece including the second battery, and the control circuit may be configured to establish connections with the first earpiece and the second earpiece by using the communication circuit; receive, from the first earpiece, the first data that is related to the charging level of the first battery; receive, from the second earpiece, the second data that is related to the charging level of the second battery; and supply charging power to at least one of the first earpiece or the second earpiece selectively, or at a different ratio, through the power interface based on at least some of the first data and the second data.

According to an embodiment of the present disclosure, the charging device 600 may be configured to include one or more booster circuits; and one or more charging circuits, wherein the control circuit may be configured to adjust at least some of the booster circuit or the charging circuit in order to thereby supply the charging power selectively or at a different ratio. The charging circuit may be configured to include a first charging circuit configured to form a charging path with the first earpiece; and a second charging circuit configured to form a charging path with the second earpiece.

According to an embodiment of the present disclosure, the charging device 600 may be configured such that the first earpiece and the second earpiece are connected to one charging circuit, and the one charging circuit may include a switch for forming a charging path between the first earpiece and the second earpiece.

According to an embodiment of the present disclosure, the charging device 600 may be configured to include an internal battery, and the control circuit may be configured to preferentially supply the charging power to the earpiece having a low charging level among the first earpiece and the second earpiece according to the charging level of the internal battery.

According to an embodiment of the present disclosure, the charging device 600 may be configured to be connected with a power supply device, and the control circuit may be configured to receive power from the power supply device and may be configured to adjust the received power in order to thereby supply the charging power selectively or at a different ratio.

The charging device 600, according to an embodiment of the present disclosure, may include a housing; a communication circuit configured to be disposed in the housing; a power interface configured to be disposed in the housing; and a control circuit configured to be electrically connected with the communication circuit and the power interface, wherein the housing includes one or more fixing members that are configured to accommodate the first earpiece including the first battery and the second earpiece including the second battery, and the control circuit may be configured to establish connections with the electronic device by using the communication circuit; receive, from the electronic device, a control signal that enables the first battery or the second battery to be charged selectively or at a different ratio; and supply charging power to at least one of the first earpiece or the second earpiece selectively, or at a different ratio, through the power interface based on the control signal.

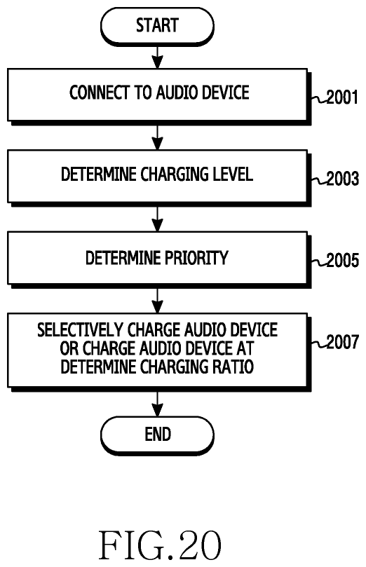

FIG. 20 is a flowchart of a method of charging an audio device in a charging device, according to an embodiment of the present disclosure.

Referring to FIG. 20, in step 2001, the controller 1870 of the charging device 600 may establish a connection to the audio devices 500 (e.g., the first audio device 510 and the second audio device 520). For example, the charging device 600 and the audio devices 500 may be functionally, electrically, or physically connected with each other in various manners based on wired interfaces or wireless interfaces. The audio devices 500 may be wiredly connected to the charging device 600 in a manner in which the audio devices 500 are mounted on a coupling recess (or a fixing member) provided in the charging device 600. The audio devices 500 may be wirelessly connected to the charging device 600 in a manner in which the audio devices 500 are placed within a configured range or a configured area.

In step 2003, if the connection to the audio devices 500 is detected, the controller 1870 may determine the battery charging level of the connected audio devices 500. According to an embodiment of the present disclosure, the controller 1870 may obtain the first charging level of the first battery of the first audio device 510 and the second charging level of the second battery of the second audio device 520 based on at least one of the first audio device 510 or the second audio device 520. The controller 1870 may obtain the charging levels from the first audio device 510 and the second audio device 520 through the interface unit 1860.

In step 2005, the controller 1870 may determine a priority for initiating the charging operation based on the first charging level and the second charging level.

In step 2007, the controller 1870 may supply charging power to the first battery of the first audio device 510 and the second battery of the second audio device 520 selectively, or at a different ratio, according to the priority. According to an embodiment of the present disclosure, the controller 1870 may adjust at least one of the booster circuit or the charging circuit to supply a different voltage to at least one of the first audio device 510 or the second audio device 520, or to the first audio device 510 and the second audio device 520.

According to an embodiment of the present disclosure, the controller 1870 may continuously check the first charging level of the first audio device 510 and the second charging level of the second audio device 520, which are currently charged, and if the first charging level and the second charging level become equal, the controller 1870 may control at least one of the booster circuit or the charging circuit in order to thereby stop the charging operation or in order to thereby supply charging power at the same ratio.

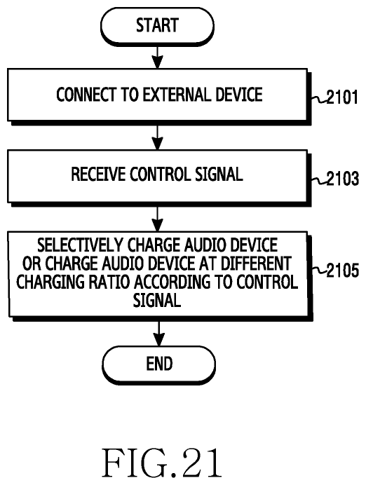

FIG. 21 is a flowchart illustrating a method of charging the audio device in the charging device, according to an embodiment of the present disclosure.

Referring to FIG. 21, in step 2101, the controller 1870 of the charging unit 600 may establish a connection to an external device. For example, the controller 1870 may establish a connection to the audio devices 500 (e.g., the first audio device 510 and the second audio device 520) based on the first communication path (e.g., pogo pin) of the interface unit 1860, and may establish a connection to the electronic device 400 based on the second communication path (e.g., the wireless communication) of the interface unit 1860. According to an embodiment of the present disclosure, the controller 1870 may establish a connection to the electronic device 400 in sequence or in parallel in response to the connection of the audio devices 500.

In step 2103, the controller 1870 may receive a control signal from the electronic device 400. For example, the controller 1870 may receive a control signal by which the electronic device 400 controls the charging operation according to the charging levels of the first audio device 510 and the second audio device 520 through the interface unit 1860. According to an embodiment of the present disclosure, the electronic device 400 may compare the first charging level related to the first battery of the first audio device 510 with the second charging level related to the second battery of the second audio device 520 in order to thereby determine the priority for charging the audio devices 500, and may provide the charging device 600 with a control signal related thereto (e.g., information on a charging target audio device or the charging power supply ratio).

In step 2105, the controller 1870 may supply charging power to the first battery of the first audio device 510 and the second battery of the second audio device 520 selectively, or at a different ratio, based on the control signal. According to an embodiment of the present disclosure, the controller 1870 may adjust at least one of the booster circuit or the charging circuit to supply a different voltage to at least one of the first audio device 510 or the second audio device 520, or to the first audio device 510 and the second audio device 520.

According to an embodiment of the present disclosure, the electronic device 400 may continuously check the first charging level of the first audio device 510 and the second charging level of the second audio device 520, which are currently charged by the charging device 600, and if the first charging level and the second charging level become equal, the electronic device 400 may provide the charging device 600 with a control signal for changing the charging operation. The controller 1870 of the charging device 600 may control at least one of the booster circuit or the charging circuit of the charging device 600 according to the control signal of the electronic device 400 in order to thereby stop the charging operation or in order to thereby supply charging power at the same ratio.

As described above, according to an embodiment of the present disclosure, a method of the charging device 600 may include establishing connections with the first earpiece and the second earpiece by using a communication circuit; receiving, from the first earpiece, the first data that is related to the charging level of the first battery; receiving, from the second earpiece, the second data that is related to the charging level of the second battery; and supplying charging power to at least one of the first earpiece or the second earpiece selectively, or at a different ratio, based on at least some of the first data and the second data.

According to an embodiment of the present disclosure, the method of the charging device 600 may include establishing a connection to an electronic device by using the communication circuit; receiving, from the electronic device, a control signal that enables the first battery or the second battery to be charged selectively or at a different ratio; and supplying charging power to at least one of the first earpiece or the second earpiece selectively, or at a different ratio, based on the control signal.

According to a battery control method and a device in accordance with an embodiment of the present disclosure, the battery (charging) levels between audio devices (the earpieces), which have batteries, respectively, and interact with each other by wireless communication, can be controlled to be the same or similar. For example, the remaining amounts of battery power for two earpieces, which are able to operate in pairs by interacting with each other through short-range communication, may be controlled to be the same or similar. The battery charging levels between audio devices are maintained to be the same or similar in order to thereby prolong the usage time in which the user can listen to stereo music through the audio devices.

The embodiments of the present disclosure disclosed herein and shown in the accompanying drawings are merely examples presented in order to easily describe the present disclosure and to help in the understanding of the present disclosure, but are not intended to limit the scope of the present disclosure. However, those skilled in the art will readily appreciate that many modifications are possible without materially departing from the scope and spirit of the present disclosure. Therefore, it is intended that all such modifications and changes or modified and changed forms of the present disclosure be included within the scope of the present disclosure as defined by the appended claims and their equivalents.

What is claimed is:

1. A mobile electronic device, comprising:
a wireless communication circuit;
a processor electrically connected to the wireless communication circuit; and
a memory electrically connected to the processor,
wherein the processor is configured to:
establish a connection to a first earpiece and a second earpiece by using the wireless communication circuit;
receive, from the first earpiece, first data that is related to a charging level of a first battery included in the first earpiece by using the wireless communication circuit;
receive, from the first earpiece or the second earpiece, second data that is related to a charging level of a second battery included in the second earpiece by using the wireless communication circuit; and
transmit, to at least one of the first earpiece or the second earpiece, one or more control signals that enable the first earpiece and the second earpiece to be configured to operate differently from each other based on at least some of the first data and the second data.

2. The device according to claim 1, wherein the processor is further configured to:
transmit, to the first earpiece, one or more control signals that enable the first earpiece to be configured to perform a second selected operation if it is determined that the charging level of the first battery is greater than the charging level of the second battery as a result of comparing the charging level of the first battery to the charging level of the second battery, and
transmit, to the second earpiece, one or more other control signals that enable the second earpiece to be further configured to perform the first selected operation.

3. The device according to claim 2, wherein a first selected operation includes outputting an audio stream, and the second selected operation includes at least one of call reception, user's voice reception, charging, activation of a sensor, or an audio signal output with a selected sound quality.

4. The device according to claim 2, wherein the processor is further configured to:
transmit, to the first earpiece, one or more other control signals that enable the second earpiece to be further configured to perform a first selected operation and a request for transmitting the one or more other control signals to the second earpiece, and
transmit, to the second earpiece, one or more other control signals that disable the second earpiece to be further configured to not perform the second selected operation.

5. The device according to claim 1, wherein the processor is further configured to transmit, to an external charging device configured to supply charging power to at least one of the first earpiece or the second earpiece, one or more other control signals that enable the external charging device to be configured to supply charging power to the second earpiece before supplying charging power to the first earpiece or at a higher ratio than that of the first earpiece if the charging level of the first battery is determined to be greater than the charging level of the second battery as a result of comparing the charging level of the first battery to the charging level of the second battery.

6. The device according to claim 1, wherein the processor is further configured to:
detect a change in a corresponding charging level between the first earpiece and the second earpiece;
establish a reconnection to the first earpiece or the second earpiece having a high corresponding charging level according to the change in the corresponding charging level between the first earpiece and the second earpiece; and
transmit the one or more control signals to the reconnected first earpiece or second earpiece.

7. An earpiece, comprising:
a housing including a portion that is detachably mounted on a user's ear;
a speaker included in the housing;
a first battery included in the housing;
one or more wireless communication circuits included in the housing;
a processor included in the housing and electrically connected to the one or more wireless communication circuits; and
a memory included in the housing and electrically connected to the processor, wherein the processor is configured to:
establish a connection to an electronic device or another earpiece by using the one or more wireless communication circuits;
receive, from the electronic device, first control information that enables the earpiece, or the earpiece and the another earpiece, to be configured to perform a first selected operation and second control information that enables the earpiece to be further configured to perform a second selected operation or disable the another earpiece to not perform the second selected operation by using the one or more wireless communication circuits;
enable the earpiece to perform the first selected operation based on the first control information; and
transmit the first control information or the second control information to the other earpiece by using the one or more communication circuits.

8. The earpiece according to claim 7, wherein the processor is further configured to:
establish connections to the electronic device and the another earpiece by using the one or more wireless communication circuits;
detect a charging level of a first battery in order to thereby create first data;
receive, from the another earpiece, second data that is related to a charging level of the second battery included in the another earpiece; and
transmit, to the another earpiece, one or more control signals for controlling the another earpiece based on at least some of the first data and the second data.

9. The earpiece according to claim 8, wherein the processor is further configured to transmit, to the electronic device, information based on the first data and the second data.

10. The earpiece according to claim 7, wherein the processor is further configured to:
establish connections to an electronic device and an earpiece by using the wireless communication circuit;
detect a charging level of a second battery in order to thereby create data;
transmit the created data to at least one of the electronic device or the earpiece;
receive, from the electronic device or the earpiece, one or more control signals that enable another earpiece to perform a selected operation; and
enable the another earpiece to perform the selected operation based on the one or more control signals.

11. An electronic device, comprising:
a housing;
a communication circuit disposed in the housing;
a power interface disposed in the housing; and
a control circuit electrically connected to the communication circuit and the power interface, wherein
the housing includes one or more fixing members configured to accommodate a first earpiece including a first battery and a second earpiece including a second battery, and
wherein the control circuit is configured to:
establish connections to the first earpiece and the second earpiece by using the communication circuit;
receive, from the first earpiece, first data that is related to a charging level of the first battery;
receive, from the second earpiece, second data that is related to a charging level of the second battery; and
supply charging power to at least one of the first earpiece or the second earpiece selectively, or at a different ratio, through the power interface based on at least some of the first data and the second data.

12. The device according to claim 11, further comprising:
one or more booster circuits; and
one or more charging circuits,
wherein the control circuit is further configured to adjust at least some of the one or more booster circuits or the one or more charging circuits in order to thereby supply the charging power selectively or at a different ratio.

13. The device according to claim 11, wherein the one or more charging circuits comprise:
a first charging circuit configured to form a charging path with the first earpiece; and
a second charging circuit configured to form a charging path with the second earpiece.

14. The device according to claim 11, wherein the first earpiece and the second earpiece are connected to one of the one or more charging circuits, and the one of the one or more charging circuits includes a switch configured to form a charging path between the first earpiece and the second earpiece.

15. The device according to claim 11, further comprising an internal battery, wherein the control circuit is further configured to preferentially supply the charging power to the first earpiece or the second earpiece having a low charging level among the first earpiece and the second earpiece according to the charging level of the internal battery.

16. The device according to claim 11, wherein the electronic device is connected to a power supply device, and the control circuit is further configured to receive power from the power supply device and adjust the received power in order to thereby supply the charging power selectively or at a different ratio.

17. The device according to claim 11, wherein the control circuit is further configured to:
establish a connection to an electronic device by using the communication circuit;
receive, from the electronic device, a control signal that enables the first battery or the second battery to be charged selectively or at a different ratio; and
supply charging power to at least one of the first earpiece or the second earpiece selectively, or at a different ratio, through a power interface based on the control signal.
